(19) United States
(12) Patent Application Publication
(10) Pub. No.: US 2015/0330026 A1
(43) Pub. Date: Nov. 19, 2015

(54) Method for Making Fibrous Structure with Visually and Elementally Balanced Designs

(71) Applicant: The Procter & Gamble Company, Cincinnati, OH (US)

(72) Inventors: Kathryn Christian Kien, Cincinnati, OH (US); Emma Lynn Sartini, Cincinnati, OH (US); Michelle Natasha Adams Hughes, Fairfield, OH (US)

(21) Appl. No.: 14/710,635

(22) Filed: May 13, 2015

Related U.S. Application Data
(60) Provisional application No. 61/992,523, filed on May 13, 2014.

(51) Int. Cl. D21H 27/02; D21H 25/00; B31F 1/07

(52) U.S. Cl. CPC D21H 27/02; B31F 1/07; D21H 25/005

(57) ABSTRACT

A method of manufacturing a strip of a fibrous structure includes imparting an interlocking motif onto a strip, the interlocking motif includes a first pattern and a second pattern interlocked with the first pattern. The first pattern has a first major design element and a first minor design element and the first major design element is at least partially imparted in a central region and the first minor design element is at least partially imparted in one of the group consisting of a first edge region and a second edge region. The second pattern includes a second major design element and a second minor design element, and the second major design element is at least partially imparted in the central region and the second minor design element is at least partially imparted in one of the group consisting of the first edge region and the second edge region.

### FIELD OF THE INVENTION

The present invention relates to fibrous structures having an embossed and/or printed design and methods for making the same.

### BACKGROUND OF THE INVENTION

Fibrous structures including sanitary tissue products, such as bath tissue, facial tissue and paper towels, are commonly used by consumers. Often fibrous structures are embossed or printed to provide an aesthetically pleasing look to the exposed surface of the products and/or provide some structural enhancement to the product (e.g., embossments assist in bonding multiple plies, providing additional depth, etc.).

While printing and embossing are common, manufacturers of fibrous structures face challenges when providing designs for their products, including but not limited to producing designs that distinguish their products from competitors, appeal to the consumers, provide insights about their products to consumers through feel and visual effects, and are efficient and cost-effective to produce.

Moreover, manufacturers have found it difficult to produce complex designs that are vertically or horizontally centered and/or aligned. Rather, designs are often diagonal along the length of the fibrous structure. The diagonal orientation is at least partially due to the methods of manufacturing fibrous structures such as sanitary tissue products having embossed designs. Indeed, emboss rolls have skewed patterns (i.e., patterns oriented at an angle) to avoid issues with balance and roll wear. If emboss patterns were aligned vertically or horizontally, the concentration of elements in one location could cause the emboss roll to wear in that area, causing additional costs of repair and slowdown in production. Likewise, emboss rolls are often used in conjunction with backing surfaces or the like to create a nip. If design elements are aligned vertically or horizontally, there may be fluctuations in the concentration of emboss elements at the nip (i.e., fluctuations of concentration throughout the cross machine direction, where there is a higher concentration of elements where dense elements are located and a lower concentration of elements in other areas). These fluctuations cause vibrations, which result in lower production rates and product quality issues, among other things. To resolve these balance issues, manufacturers skew their emboss patterns on the emboss roll. However, skewing precludes the ability to provide vertically and horizontally aligned patterns on the fibrous structures.

With printing apparatuses, manufacturers often manually lay out design elements to ward against balance issues. Obviously, manual placement of each design element to avoid sheet balance issues is not cost-effective or efficient. One such balance issue—sheet height imbalance—occurs when a design element is repeated in the same spot about a rolled fibrous structure or stacked fibrous structure such that the stacked or rolled product exhibits an undesired high caliper in one location as compared to the surrounding areas. The high caliper can be caused by a higher concentration of ink in that area and is not an intended consequence of the design. Sheet height imbalance may also occur with a repeated embossed element.

In addition, manufacturers also face the challenge of creating complex designs that visually appear centered, vertically aligned and/or horizontally aligned. Again, production methods are partially responsible for such challenge. For example, printing equipment may not perfectly and consistently register elements and embossment elements are skewed as noted above.

Likewise, manufacturers have been unable to dispose complex designs on rolled products in a way that allows such designs to continue uninterrupted from the last sheet of the roll to the underlying sheet such that the design is visually continuous about the circumference of the roll regardless of where the end of the terminal sheet lands.

Further to the above, high speed production of fibrous structures such as sanitary tissue products requires simple designs that are easily repeatable, where print files and/or embossment patterns can be easily manufactured and replicated if necessary. Complex designs, until now, required multiple files, numerous design elements and size alterations when reproducing the designs on different size products.

Thus, there is a need to provide a balanced, non-skewed, visually centered and/or vertically aligned and/or horizontally aligned printed and/or embossed design for fibrous structures like sanitary tissue products. Likewise, there is a need to provide enhanced consumer-appealing designs for fibrous structures. Further, there is a need to solve these issues in a cost-effective and efficient manner and/or a manner that reduces issues with roll wear and nip balance.

### SUMMARY OF THE INVENTION

A method of manufacturing a strip of a fibrous structure is disclosed. The method includes the steps of:

providing a strip, the strip having:
a strip width disposed between a first edge and a second edge opposite the first edge,
a main centerline extending in a longitudinal direction and being substantially equidistant between the first edge and the second edge,
a central region extending in a longitudinal direction and having a central width, wherein the central width is less than the strip width and the central region extends laterally outwardly on each side of the main centerline, and
a first edge region and a second edge region, wherein the first edge region and the second edge region each extend outward from the central region toward at least one of
the first edge and the second edge; and

imparting an interlocking motif onto the strip, the interlocking motif comprising a first pattern and a second pattern interlocked with the first pattern, wherein:
the first pattern comprises a first major design element and a first minor design element and the first major design element is at least partially imparted in the central region and the first minor design element is at least partially imparted in one of the group consisting of the first edge region and the second edge region; and the second pattern comprises a second major design element and a second minor design element and the second major design element is at least partially imparted in
the central region and the second minor design element is at least partially imparted in one of the group consisting of the first edge region and the second edge region.

In another embodiment, a method of making a fibrous structure having an interlocking motif includes the steps of:

providing a fibrous structure having a machine direction and a cross machine direction;

imparting an interlocking motif on the fibrous structure, the interlocking motif having:
a width, W, in the cross machine direction and a length, L, in the machine direction;
an interlocking motif centerline extending longitudinally, wherein the interlocking motif centerline is substantially parallel to the machine direction; and
a first pattern and a second pattern partially overlapping the first pattern; and

repeating the interlocking motif in a lock and step manner to form a repeating interlocking motif on the fibrous structure, the repeating interlocking motif having a repeat width, RW, in the cross machine direction.

In still another embodiment, a method for creating a continuing design includes the steps of:

providing a fibrous structure having a machine direction and a cross machine direction;

imparting a repeating design on the fibrous structure, wherein the repeating design comprises a design having a design length, DL, in the machine direction and said design is repeated in the machine direction throughout the repeating design; and

winding the fibrous structure into a convolutely wound log having a circumference, C₁, wherein the circumference, C₁, is substantially equivalent to the design length, DL.

### BRIEF DESCRIPTION OF THE DRAWINGS

FIG. 1 is a plan view of a fibrous structure in accordance with one nonlimiting embodiment of the present invention;

FIG. 2 is a plan view of a fibrous structure in accordance with one nonlimiting embodiment of the present invention;

FIG. 3 is a schematic representation of design elements in accordance with one nonlimiting embodiment of the present invention;

FIG. 4 is a schematic representation of one design element in accordance with a nonlimiting embodiment of the present invention;

FIG. 4A is a plan, sectional view of a strip in accordance with one nonlimiting embodiment of the present invention;

FIG. 5 is a plan view of a fibrous structure in accordance with one nonlimiting embodiment of the present invention;

FIG. 6 is a sectional view of the fibrous structure of FIG. 5;

FIG. 7 is a plan view of a fibrous structure in accordance with another nonlimiting embodiment of the present invention;

FIGS. 8A and 8B are schematic representations of an elementally balanced interlocking motif in accordance with nonlimiting embodiments of the present invention;

FIG. 9 is a plan view of a strip in accordance with one nonlimiting embodiment of the present invention;

FIG. 10 is a schematic representation of a pattern in accordance with one nonlimiting embodiment of the present invention;

FIG. 11A is a schematic representation of a pattern in accordance with another nonlimiting embodiment of the present invention;

FIG. 11B is a schematic representation of an interlocking motif in accordance with a nonlimiting embodiment of the present invention;

FIG. 12A is a schematic representation of emboss roll in accordance with a nonlimiting embodiment of the present invention;

FIG. 12B is a schematic representation of a prior art emboss roll;

FIG. 13 is a schematic representation of a repeating motif in accordance with a nonlimiting embodiment of the present invention;

FIG. 14 is a schematic representation of a repeating motif in accordance with another nonlimiting embodiment of the present invention;

FIG. 15 is a schematic representation of a convolutely wound log in accordance with one nonlimiting embodiment of the present invention;

FIG. 16 is a schematic representation of a fibrous structure having a repeating motif in accordance with a nonlimiting embodiment of the present invention;

FIG. 17 is a schematic representation of a design in accordance with a nonlimiting embodiment of the present invention;

FIG. 18 is a partial plan view of a fibrous structure in accordance with a nonlimiting embodiment of the present invention;

FIGS. 19A and 19B are schematic representations of a convolutely wound log in accordance with nonlimiting embodiments of the present invention;

FIG. 20 is a schematic representation of a convolutely wound log in accordance with one nonlimiting embodiment of the present invention;

FIG. 21 is a schematic representation of an imparting apparatus in accordance with one nonlimiting embodiment of the present invention;

FIG. 22 is a schematic representation of an imparting apparatus in accordance with another nonlimiting embodiment of the present invention; and

FIG. 23 is a schematic representation of an apparatus for measuring roll diameter and/or roll compressibility in accordance with a nonlimiting embodiment of the present invention.

### DETAILED DESCRIPTION OF THE INVENTION

“Brand information” as used herein means any descriptions, depictions, objects or other indicia relating to a brand (i.e., a single source identifier which identifies a product and/or service as exclusively coming from a single commercial source). Nonlimiting examples of a brand are PUFFS® facial tissue, CHARMIN® bath tissue, and BOUNTY® paper towels. PUFFS®, CHARMIN® and BOUNTY® are also trademarks. Nonlimiting examples of brand information are brand names, brand insignia, slogans, mascots, endorsements, certifications, recommendations and claims regarding brand performance, quality, history recognition or consumers' preferences for the brand.

“Brand insignia” as used herein means objects, character representations, words, colors, shapes or other indicia that can be used to distinguish, identify or represent the manufacturer, retailer, distributor or brand of a product, including but not limited to trademarks, logos, emblems, symbols, designs, figures, fonts, lettering, crests or similar identifying marks.

“Pattern” as used herein means an arrangement of one or more design elements.

“Design element” as used herein means a shape or combination of shapes that visually create a distinct and discrete component, regardless of the size or orientation of the component. A design element may be present in one or more patterns. A design element may be present one or more times within one pattern. In one nonlimiting example, the same design element is present twice in one pattern—the second instance of the design element is smaller than the first instance. One of skill in the art will recognize that alternative arrangements are also possible.

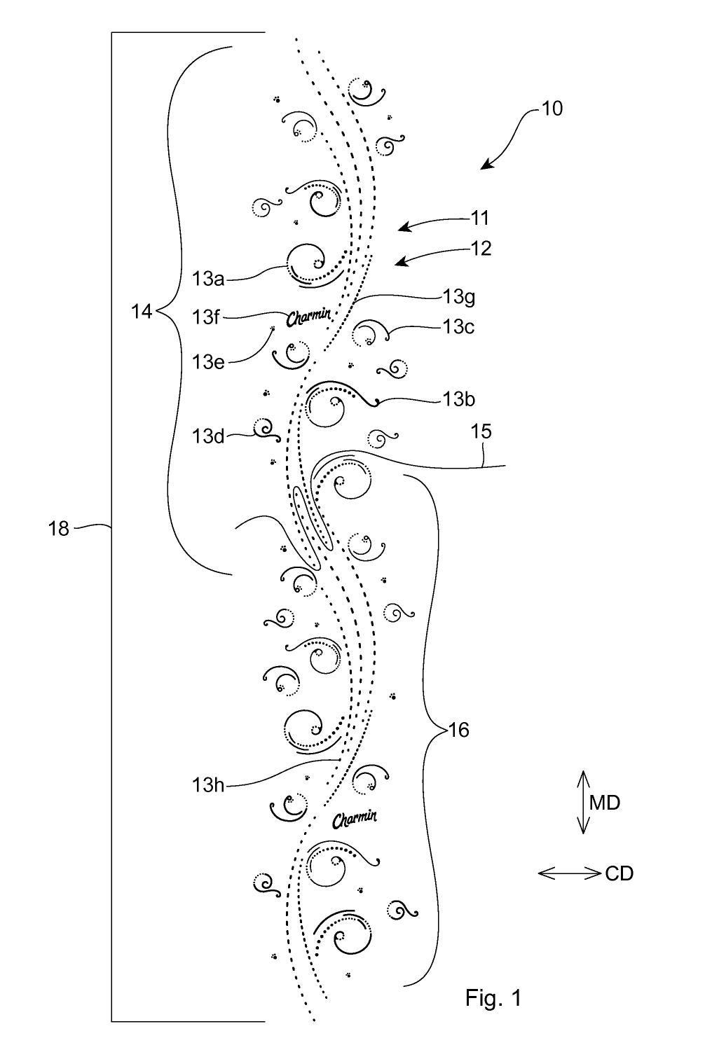

“Concentrated design element(s)” generally are the densest design element(s) on a fibrous structure, emboss apparatus (e.g., emboss roll) or printing apparatus (e.g., print plate). Whether a design element constitutes a concentrated design element is based on relative measurements. Each design element is measured by drawing a perimeter outline that fully surrounds the entire element. The perimeter outline must be at have an area of at least 0.0625 inches. Design elements that can be fully captured with a perimeter outline having an area of less than 0.0625 inches should be discounted from the analysis. A concentrated design element will have an emboss and print area that is at least 1.25 times the emboss and print area of another design element present on the fibrous structure, emboss apparatus or printing apparatus. In an embodiment, there may be more than one concentrated design element present. In such embodiment, the relative emboss and print area of the two concentrated design elements may not differ by a factor 1.25; however, each will have a emboss and print area that is at least 1.25 times greater than the emboss and print area of another design element located on the same fibrous structure, print apparatus or emboss apparatus. By way of example, in FIG. 1, the word “Charmin” is a concentrated design element. In general, any embossed or printed word or noticeable brand information is a concentrated design element as long as it meets the emboss and print area requirements explained above.

“Fibrous structure” as used herein means a structure that comprises one or more fibrous elements. In one example, a fibrous structure according to the present invention means an association of fibrous elements that together form a structure capable of performing a function. Nonlimiting examples of fibrous structures of the present invention include paper (such as a sanitary tissue product) and fabrics (including woven, knitted, and non-woven).

Nonlimiting examples of processes for making fibrous structures include known wet-laid papermaking processes, air-laid papermaking processes, and wet, solution, and dry filament spinning processes, for example meltblowing and spunbonding spinning processes, that are typically referred to as nonwoven processes. Further processing of the formed fibrous structure may be carried out such that a finished fibrous structure is formed. For example, in typical papermaking processes, the finished fibrous structure is the fibrous structure that is wound on the reel at the end of papermaking. The finished fibrous structure may subsequently be converted into a finished product, e.g. a sanitary tissue product.

“Fibrous element” as used herein means an elongate particulate having a length greatly exceeding its average diameter, i.e. a length to average diameter ratio of at least about 10. A fibrous element may be a filament or a fiber. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Nonlimiting examples of fibers include cellulosic fibers (e.g., wood pulp, cotton linters, rayon, lyocell, bagasse, grasses or grain) and synthetic staple fibers (e.g., polypropylene, polyethylene, polyester, copolymers thereof, rayon, glass fibers and polyvinyl alcohol fibers).

Filaments are typically considered continuous or substantially continuous in nature. Filaments are relatively longer than fibers. Nonlimiting examples of filaments include meltblown and/or spunbond filaments. Nonlimiting examples of polymers that can be spun into filaments include natural polymers or synthetic polymers.

Also applicable to the present invention are fibrous elements derived from recycled paper.

“Sanitary tissue product” as used herein means a soft, relatively low density fibrous structure useful as a wiping implement for post-urinary and post-bowel movement cleaning (toilet tissue), for otorhinolaryngological discharges (facial tissue), multi-functional absorbent and cleaning uses (paper towels) and wipes, such as wet and dry wipes. The sanitary tissue product may be convolutely wound upon itself about a core or without a core to form a sanitary tissue product roll or the sanitary tissue product may be in the form of discrete sheets. The sanitary tissue product can be single-ply or multi-ply. In general, any sanitary tissue product made by known papermaking methods can be utilized in the present invention. Therefore, the description below is nonlimiting with respect to the particular sanitary tissue product to be embossed and/or printed on, the particular manufacturing method, or the particular format (e.g., rolled or stacked/interleaved).

The sanitary tissue products of the present invention may comprise additives such as softening agents, temporary wet strength agents, permanent wet strength agents, bulk softening agents, lotions, silicones, wetting agents, latexes, patterned latexes and other types of additives suitable for inclusion in and/or on sanitary tissue products. The sanitary tissue product of the present invention may be manufactured by any process known in the art prior to being embossed or printed on in accordance with the present invention.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

As used herein, the articles “a” and “an” when used herein, for example, “an anionic surfactant” or “a fiber”, is understood to mean one or more of the material that is claimed or described.

“Embossing” refers to a type of paper finish obtained by mechanically impressing a design on the finished paper with engraved rolls, plates, or belts in combination with complimentary or mating metallic, cross-linked rubber, or soft rubber or rubber-like rolls, or belts.

“Printing” refers to a type of finish applied to the absorbent product that imparts visually perceptible design through the application of color. One or more colors can be applied mechanically by means commonly known in the art such as applying ink by a gravure roll, flexographic plates, ink jet printers or other known means.

To be “elementally balanced” as used herein means that an item, such as a pattern or an interlocking motif, (i) can be printed or embossed without substantial vibration or wear in an emboss roll or printing apparatus from which the item was imparted, and/or (ii) can be printed or embossed without creating an area of sheet height imbalance. An example of an elementally balanced pattern is depicted in FIG. 1. Those of skill in the art will appreciate that a pattern or motif on an emboss apparatus or on a print apparatus can be directly translated to a fibrous structure (i.e., the design on the emboss apparatus and/or printing apparatus can be substantially replicated on the fibrous structure) such that, for example, a pattern balanced on an emboss roll is balanced on a fibrous structure.

“Non-Diagonal” as used herein means an item, such as a pattern or an interlocking motif, that has a centerline extending longitudinally through the item that is substantially parallel to the MD or that is substantially parallel to the CD.

“Lock and step” as used herein refers to a translation of an item, such as repeating interlocking motifs, having both a MD vector component and a CD vector component. As with any translation, every point in the first instance of the item is moved in the same direction and the same distance to arrive at the corresponding point in the second instance of the item. In the case of lock and step as defined herein, the direction in which the points are moved comprises both a MD component and a CD component.

“Visually balanced” as used herein means that an item, such as a pattern or interlocking motif, visually appears symmetrical and/or centered.

### Overview

As shown in FIG. 1, a strip 10 of a fibrous structure 11, such as a sanitary tissue product 12 is provided. The fibrous structure 11 has a machine direction, MD, and a cross-machine direction, CD. The strip 10 comprises one or more design elements 13 disposed in various regions of the strip 10. By way of example, specific design elements 13a-13h are illustrated in FIG. 1. The design elements 13 may be printed and/or embossed onto the strip 10. In addition, the design elements 13 form patterns 14, 16. The patterns 14, 16 interlock at an imaginary intersection line 15 to form an interlocking motif 18. The interlocking motif 18 and/or one or more of the patterns 14, 16 may be elementally balanced and/or visually balanced. In addition, as illustrated later, the interlocking motif 18 may be repeated in a lock and step manner, which provides the opportunity to helix the interlocking motif 18 about a roll without skewing or jeopardizing vertical and or horizontal alignment of the overall motif 18, the individual patterns 14, 16, and/or the individual design elements 13.

### Interlocking Patterns

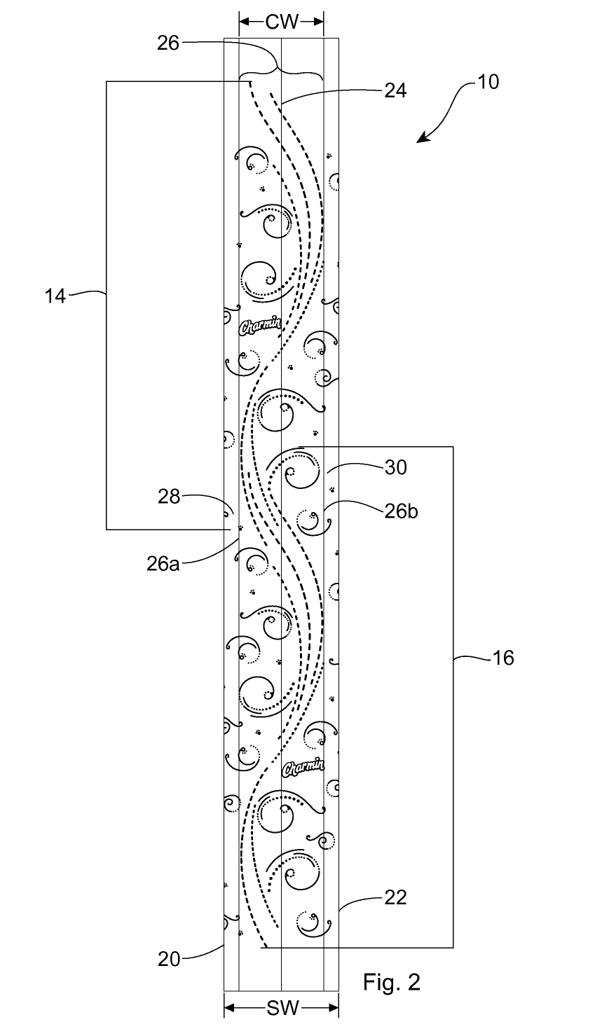

FIG. 2 illustrates that the strip 10 includes a first edge 20 and a second edge 22 that is substantially opposite the first edge 20. The first edge 20 and second edge 22 may be generally parallel and define a strip width, SW, therebetween. The strip width SW can be from about 15 inches to about 13 inches or from about 12 inches to about 11 inches or from about 10 inches to about 6 inches or from about 5 inches to about 3 inches, reciting, for each of the disclosed ranges, all 0.1 increments therebetween.

The strip 10 also includes a main centerline 24, which extends in a longitudinal direction and is substantially equidistant between the first edge 20 and the second edge 22. Extending laterally outwardly from the main centerline 24 is a central region 26. The central region 26 extends in a longitudinal direction, and can extend an equal distance outward on each side of the main centerline 24 or at an unequal distance about either side of the main centerline 24. The central region 26 has a central width, CW, which is less than the strip width, SW. The central width CW can be from about 97% to about 25% and/or from about 85% to about 40% and/or from about 75% to about 55% or about 70% of the strip width SW. For example, in one embodiment, the strip width SW can be equal to about 4 inches and the central width CW can be about 75% of the strip width SW, in which case the central width CW is equal to about 3 inches.

One or more edge regions 28, 30 can extend laterally, outwardly on either side of the central region 26. A first edge region 28 can extend from the central region 26 towards the first edge 20. In one nonlimiting example, the first edge region 28 extends from the boundary 26a of the central region 26 that is most proximate to the first edge 20 to the first edge 20. A second edge region 30 can extend from the central region 26 towards the second edge 22. In one nonlimiting example, the second edge region 30 extends from the boundary 26b of the central region 26 that is most proximate to the second edge 22 to the second edge 22. Both the first edge region 28 and the second edge region 30 extend longitudinally as well. The first edge region 26 can be the same width as the second edge region 28, or the two regions 26, 28 may comprise different widths. The width of each edge region 26, 28 may be dependent on the central width, CW, and the disposition of the central region 26. The sum of the widths of the first edge region 28 and the second edge region 30 is generally the difference between the strip width, SW, and the central width, CW.

The strip 10 also includes a first and second pattern 14, 16 (as illustrated in FIGS. 1 and 2), each having one or more design elements 13. The first pattern 14 may be different from the second pattern 16. Alternatively, the first pattern 14 and the second pattern 16 may be the same. In one embodiment, the first pattern 14 is different from the second pattern 16 but the two patterns 14, 16 comprise one or more of the same design elements 13. In another embodiment, the two patterns 14, 16 comprise different design elements 13.

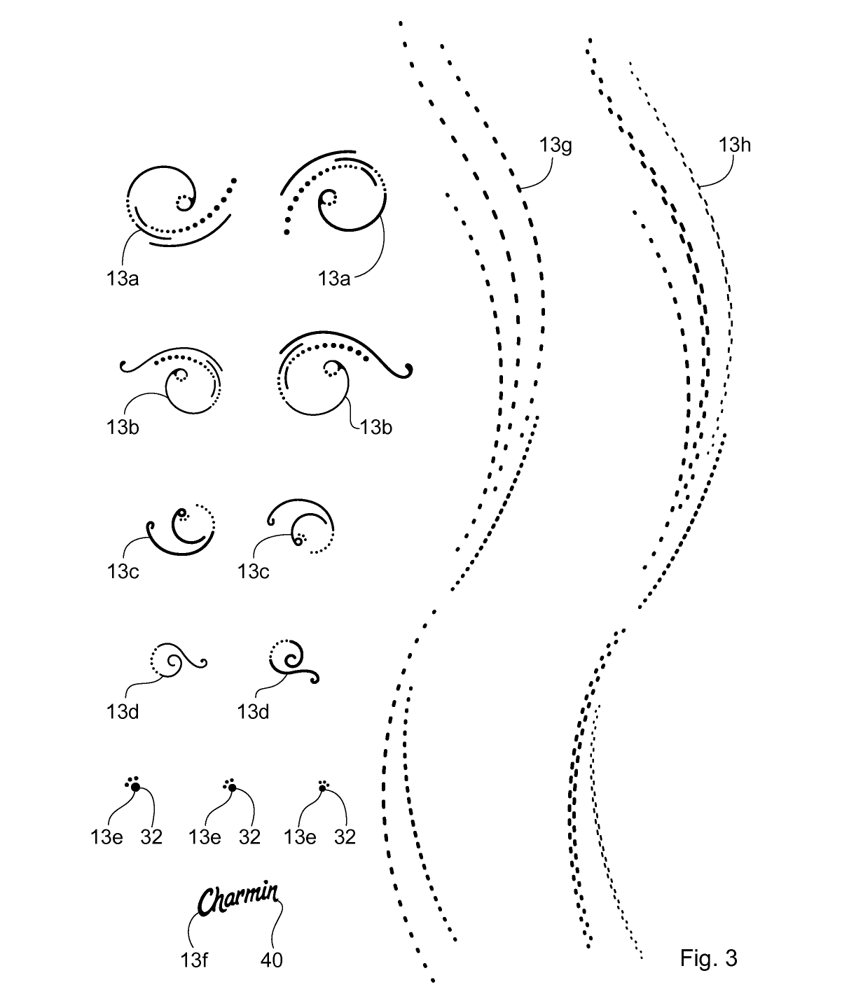

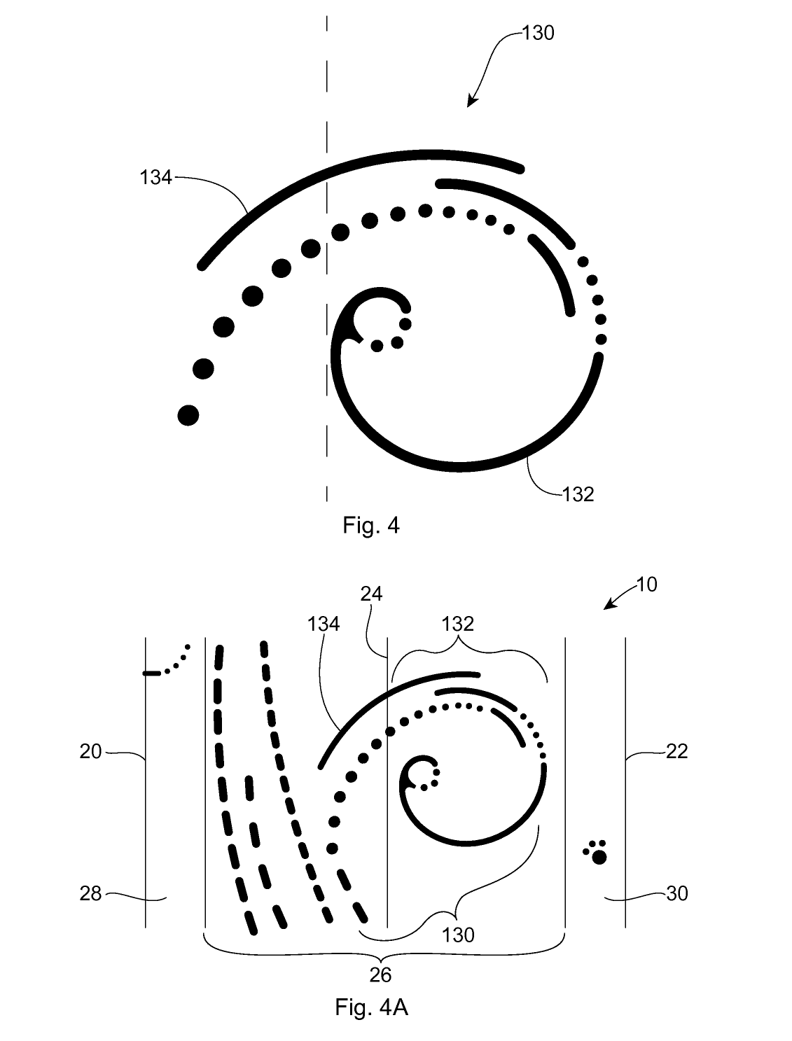

Countless design elements 13 may be selected from when developing a pattern 14, 16. A design element 13 may include any shape, line or combination of shapes and/or lines. In one nonlimiting example, the design element 13 is a circle. In another nonlimiting example, the design element 13 has a circular portion. The present inventors have discovered that specific design elements 13a-13h (illustrated in FIG. 3) are suitable for use in the present invention because the circle-like structures and wave structures connote water, cleaning and softness to consumers. Moreover, circles and circle-like figures have no top or bottom, or up or down, and therefore creating visually and elementally balanced patterns 14, 16 with such shapes presents far fewer issues than balancing shapes with sharp edges, multiple sides and/or asymmetrical elements. In one nonlimiting example depicted in FIG. 4, an exemplary design element 130 can comprise a main portion 132, such as a main circular portion. The design element 130 can further comprise features that are associated with but different from the main portion 132, such as a tail portion 134. In another nonlimiting example, the main portion 132 may be substantially closed from a visual perspective using, for example, Gestalt's theory of visual perception pertaining to closure. Closure occurs when there is enough of a shape present that a person is able to mentally complete the shape so as to perceive a broken figure as a whole figure. Viewing FIG. 4, the main portion 132 of the exemplary design element 130 can be perceived as substantially closed despite the use of broken and/or dotted lines. In a further embodiment, the main portion 132 of a design element 130 is substantially disposed within the central region 26 as shown for example in FIG. 4A.

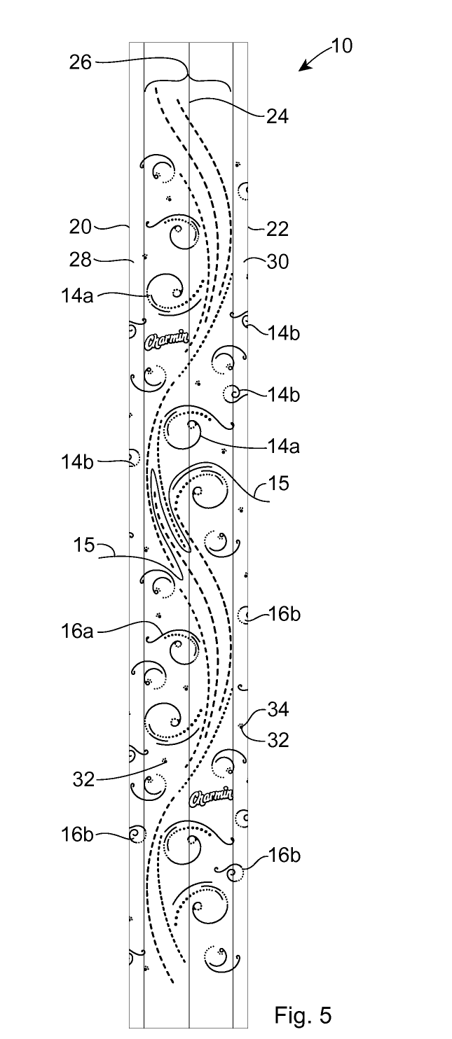

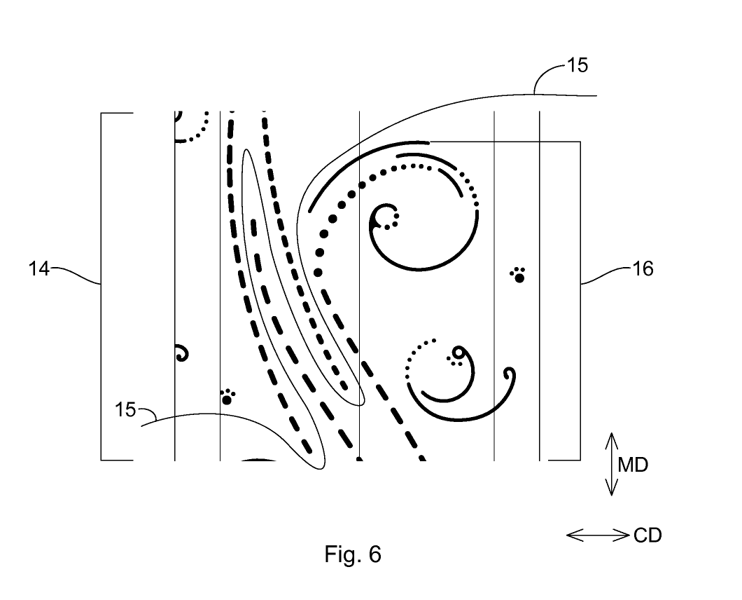

The patterns 14, 16 interlock to form an interlocking motif 18. As shown in FIGS. 5 and 6, the first pattern 14 and second pattern 16 are interlocked at an imaginary line of intersection 15 to form an interlocking motif 18. The patterns 14, 16 may be interlocked by overlapping one or more elements 14a, 14b of the first pattern 14 with one or more elements 16a, 16b of the second pattern 16. The patterns 14, 16 may overlap in the MD and/or in the CD, and thereby result in interlocking in the MD and/or CD respectively. The interlocking motif 18 may be elementally balanced. Further, the interlocking motif 18 may repeat in the machine direction and/or cross machine direction. Where the interlocking motif 18 repeats, the repetition may be done in a lock and step manner as discussed more fully below. Although only two patterns 14, 16 are described for illustrative purposes, multiple additional patterns may be interlocked with the first and/or second patterns 14, 16 in creating the interlocking motif 18.

Visually Balanced Pattern and/or Interlocking Motif

The design elements 13 may be disposed within the pattern 14, 16 in any suitable means to provide apparent visual symmetry and/or centering throughout the pattern 14, 16 and/or interlocking motif 18. In one embodiment, design elements 13 may be arranged in accordance with the teachings of commonly assigned U.S. patent application Ser. No. 13/899,897 to Sartini in order to achieve apparent visual symmetry and/or centering. Further, the design elements 13 may be disposed such that one or more of the patterns 14, 16 is elementally balanced.

In one nonlimiting example, the design elements 13 can include major and minor design elements. “Major design elements” will generally be partially disposed in the central region 26 such that they generally will not be cut off from the strip 10 and such that they provide a focal point for the consumer. In one nonlimiting example, more than about 75% or more than about 90% of the major design element is disposed in the central region 26. In another nonlimiting example, the main portion 132 of a major design element is substantially disposed in the central region 26. “Minor design elements” will generally be at least partially disposed in one of the edge regions 28, 30 and can be cut off of the strip 10 without undermining the perceived symmetry and/or centering. In one nonlimiting example, more than 25%, or more than 30%, or more than 50%, or more than 75%, or more than 90% of the minor design element may be cut off of the strip. By “cut off”, it is meant that only a portion of the design element is visible on the strip. For example, the design element 13 may be terminated by the edge, rendering the design element 13 incomplete when viewing the strip 10. In another nonlimiting example, the minor design element may be partially disposed in the central region 26 and partially disposed in one of the edge regions 28, 30. In such nonlimiting example, more than 50% of the minor design element may be disposed in one of the edge regions 28, 30 and less than 50% of the minor design element may be disposed in the central region 26. In yet another nonlimiting example, the minor design element may comprise a main portion 132 and the main portion 132 may be substantially and/or partially disposed in one of the edge regions 28, 30. In one embodiment, major design elements can be larger than minor design elements. In another embodiment, minor design elements may be the same size as or larger than major design elements.

In a further embodiment, the first pattern 14 or second pattern 16 can comprise one or more filamentary design elements 13g or 13h. Filamentary design elements can have the appearance of being thin, curvilinear line elements, even though, as shown, for example, in FIG. 3 (shown in this embodiment as a group of 3-4 individual filamentary design elements, but can be one or more), they can be comprised of closely spaced dots or short line elements to give the appearance of a linear element. Filamentary design elements 13g or 13h can be fully disposed in the central region 26. In an embodiment, filamentary design elements 13g or 13h are curvilinear elements that can each have a motif associated with it, and each can be bounded by boundaries 26a and 26b of the central region 26. Filamentary design elements can span one or more sheets of a fibrous structure such as bath tissue, and can span two, three, four, or more sheets to give an appearance of continuity from sheet to sheet.

Returning to FIG. 5, the first pattern 14 can comprise one or more first major design elements 14a, which are at least partially disposed in the central region 26. The first pattern 14 may also comprise one or more first minor design elements 14b, which are at least partially disposed in either the first edge region 28 or the second edge region 30. In yet another nonlimiting example, one of the first minor design elements 14b may be partially disposed in the central region 26 and partially disposed one of the edge regions 28, 30. As discussed above, the majority of the first minor design element 14b may be disposed in the edge region 28, 30. In an alternative embodiment, a first minor design element 14b is not present in the central region 26. Further, the first minor design element 14b may be cut off of the strip 10.

In a further embodiment, the second pattern 16 can comprise one or more second major design elements 16a, which are at least partially disposed in the central region 26. The second pattern 16 may also comprise one or more second minor design elements 16b, which are at least partially disposed in either the first edge region 28 or the second edge region 30. In yet another nonlimiting example, a second minor design element 16b may be partially disposed in the central region 26 and partially disposed one of the edge regions 28, 30. As discussed above, the majority of the second minor design element 16b may be disposed in the edge region 28, 30. In an alternative embodiment, a second minor design element 16b is not be present in the central region 26. Further, the second minor design element 16b may be cut off of the strip 10. For clarity in the illustration, only a few major and minor elements are identified on FIG. 5.

The interlocking motif 18 can further comprise a third design element 32. The third design element 32 may comprise any shape or design or any combination of shapes and/or designs. In one nonlimiting example, the third design element 32 is in the shape of a brand insignia, such as a character representation associated with a brand. In one nonlimiting example, illustrated in FIG. 5 for example, the third design element 32 may comprise a paw which may be associated with brand insignia such as the CHARMIN® bath tissue bear, a trademark of The Procter & Gamble Company. In another nonlimiting example, the third design element 32 may comprise a cloud, blanket, baby, man, and/or other indicia or symbols that can be associated with characteristics of sanitary tissue products 12, such as strength and/or softness. In a further embodiment, the third design element 32 may be at least partially disposed on an adhesive area 34. The third design element 32 may be used to cover adhesive areas 34, rendering adhesive areas 34 less consumer noticeable. The third design element 32 may be disposed in the first edge region 28, the second edge region 30, and/or the central region 26. In one nonlimiting example, the third design element 32 may be a minor design element, having any of characteristics of minor design elements as discussed above.

The interlocking of the patterns 14, 16 and the layout of their associated elements 14a, 14b, 16a, 16b provides the visual appearance of centering, regardless of whether either pattern 14, 16 is actually centered on the strip 10 or symmetrical. The interlocking the patterns 14, 16 provides visual continuity between the two patterns. Further, the interlocking can make two or more different patterns 14, 16 appear as one more complex design (i.e., the interlocking motif 18). This can be advantageous when designing templates for printers and emboss rolls; essentially, the designer can utilize fewer patterns while making more complex, visually appealing overall designs.

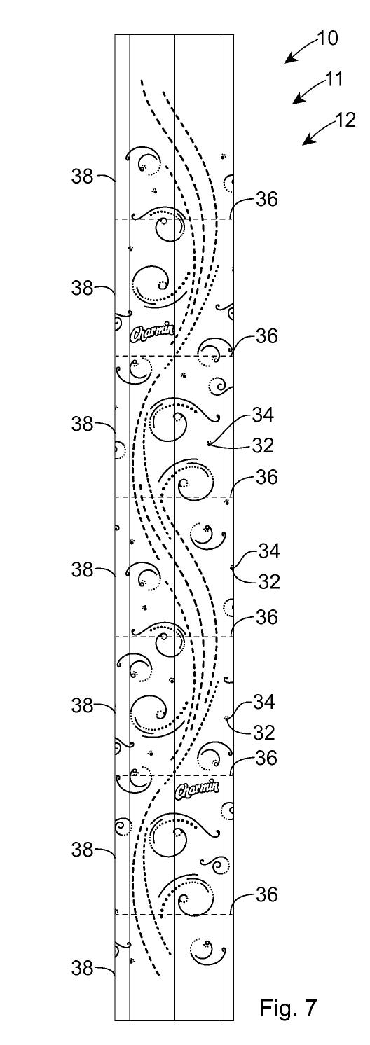

In a further embodiment depicted in FIG. 7, the strip 10 can comprise one or more lines of weakness 36, such as a perforated line. The line(s) of weakness 36 allow one or more sheets 38 to be separated from the sanitary tissue product 12. The line of weakness 36 may be substantially parallel to the cross-machine direction. The line of weakness 36 may be substantially straight or curvilinear. The interlocking motif 18 may extend in the machine direction such that it covers multiple sheets 38. In one nonlimiting example, the interlocking motif 18 extends more than one sheet 38, or about three sheets 38, or about four sheets 38, or more than about three sheets 4, or from about three sheets 38 to about seven sheets 4. Likewise, one or more of the patterns 14, 16 may extend in the machine direction such that such pattern 14, 16 extends more than one sheet 38. One of skill in the art will recognize that the extension of the interlocking motif 18 can depend on the number of patterns 14, 16 utilized, the size of the design elements 13, and/or the spacing between design elements 13 in a given pattern 14, 16. As shown in FIG. 7, extending the interlocking motif 18 (and/or one or more of the patterns 14, 16 therein) across the lines of weakness 36 can cause the end-user to perceive each sheet 38 in a series of sheets 38 as comprising a unique design; however, the designer is only required to use a small number of patterns to create this perceived complexity. The sheets 38 may be the same size or different sizes.

Elementally Balanced Patterns and/or Interlocking Motif

In addition to the above, the interlocking of the patterns 14, 16 in the CD and/or MD can further ensure that the design elements 13 are elementally balanced. In other words, overlapping design elements 13 in the CD and/or MD can help to level the concentration of embossment impressions or printing throughout CD and/or MD respectively. In this way, the likelihood of imbalance during embossment or printing processes is decreased. Likewise, sheet height imbalance is unlikely to occur as the design elements 13 are dispersed in a more deliberate manner through the fibrous structure 11.

Further, by disposing design elements such that they are balanced across the strip 10 in the MD and/or CD also creates elemental balance. One means of doing so is by arranging the elements 13 in a design template to achieve balance on the emboss apparatus or printing apparatus. While manual arrangement is time-consuming and undesirable, the present inventors have found that designing a couple of patterns 14, 16 that are elementally balanced and then interlocking and repeating those patterns 14, 16 minimizes the effort entailed in achieving elemental balance throughout a fibrous structure 11. Moreover, the lock and step repetition discussed in detail below further reduces manual effort.

### Balanced Concentrated Elements

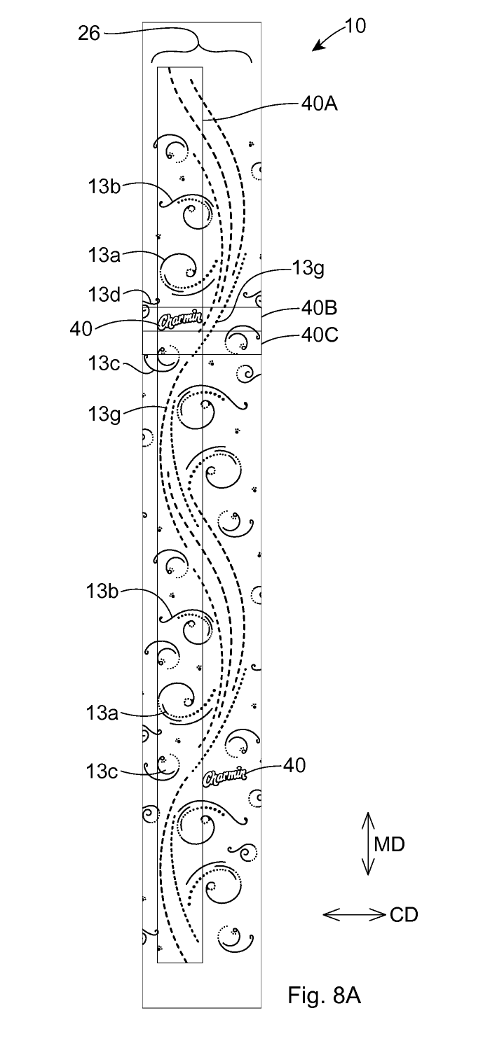

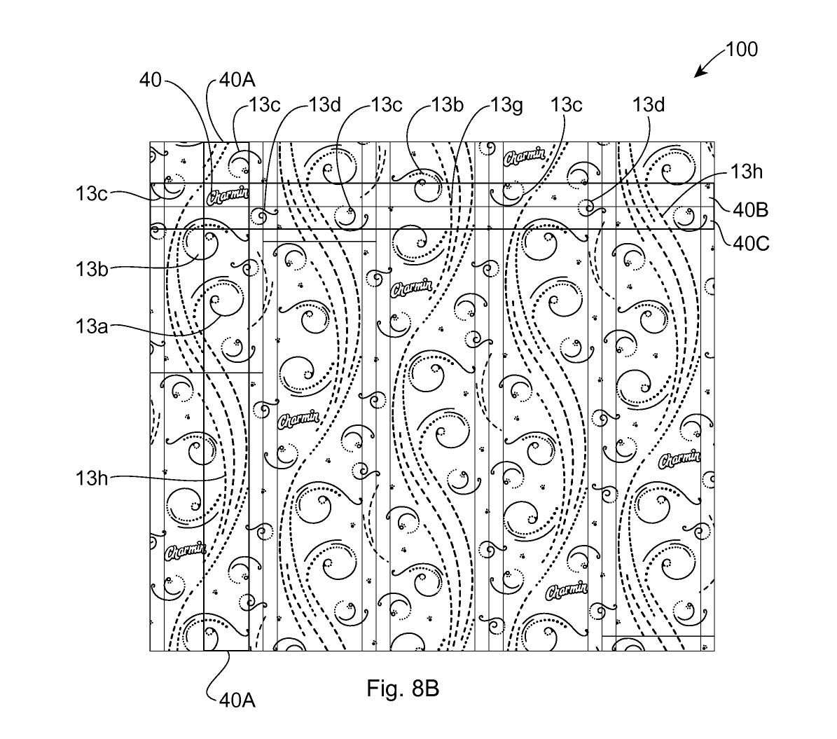

Turning to FIGS. 8A and 8B, the interlocking motif 18 may include one or more concentrated design elements 40. The concentrated design elements 40 may be at least partially disposed in the central region 26. In one nonlimiting example, the concentrated design element 40 may constitute a major design element, having the characteristics of a major design element as discussed above.

In one embodiment, the interlocking motif 18 may comprise at least one concentrated design element 40 and be elementally balanced. For example, the concentrated design element 40 may be placed in relation to one or more design elements 13 that are not concentrated, such that the aggregate emboss and print areas of the non-concentrated design elements 13 substantially equates to the emboss and print area of the concentrated design element 40. To further exemplify, FIG. 8A comprises a first box 40A and a second box 40B. The first box 40A illustrates that the concentrated element 40 is elementally balanced in the MD. In other words, the concentrated element 40 is positioned between various non-concentrated elements 13a-13g or portions of non-concentrated elements 13a-13g that counterbalance the concentrated element 40 in the MD such that the potential for causing uneven roll wear is reduced. The second box 40B illustrates that the concentrated element 40 is elementally balanced in the CD. In other words, the concentrated element 40 is positioned such that design elements 13d, 13g or portions of design elements 13d, 13g throughout the CD of the second box 40B are counterbalanced. In this way, nip imbalance (stemming from uneven concentrations of elements 13 at the nip) is less likely to occur. A nip may be disposed in the CD and be represented by the second box 40B. Thus, balancing elements 13 within the second box 40B can reduce nip imbalance. Further, the design elements 13 or portions of design elements 13 disposed in the second box 40B (including the concentrated design element 40) may be counterbalanced with design elements 13 located in a third box 40C, which can represent a second instance of a nip interacting with the fibrous structure 11.

One of skill in the art will recognize that fibrous structures 11 are often manufactured, printed and/or embossed in large sized parent rolls 100 or the like, wherein the MD and CD dimensions are longer than those of a strip 10. In such case, the interlocking motif 18 may be repeated throughout the CD as shown in FIG. 8B for example and discussed in detail later. Elemental balance may be achieved on the parent roll 100 sized fibrous structure 11 as shown in FIG. 8B utilizing the same principles as discussed with respect to the strip.

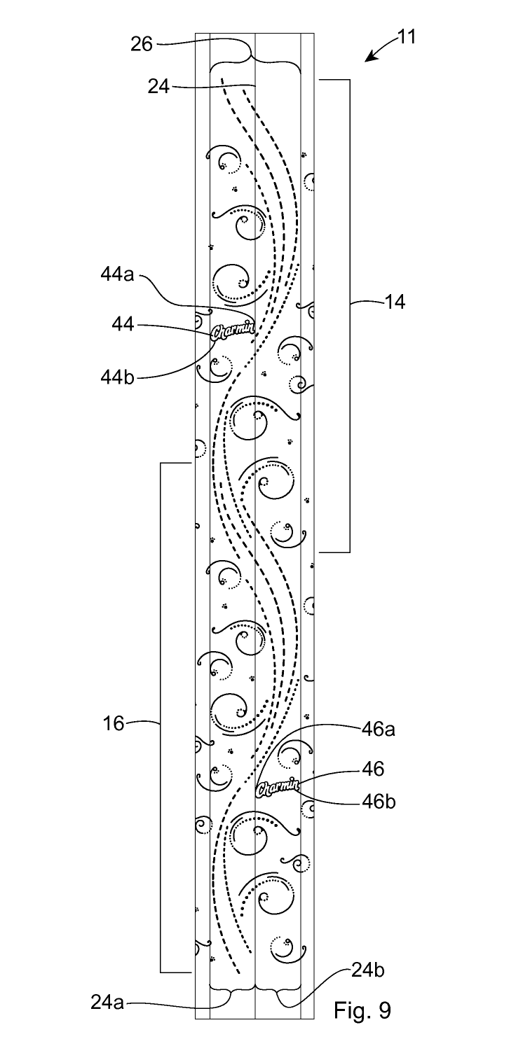

In a further embodiment, as shown in FIG. 9, the fibrous structure 11 comprises a first concentrated design element 44. More specifically, the first pattern 14 may comprise the first concentrated design element 44. The first concentrated design element 44 may be at least partially disposed in the central region 26. In one nonlimiting example, the first concentrated design element 44 is at least partially disposed on the main centerline line 24. In another nonlimiting example, the first concentrated design element 44 is a major design element. In a further nonlimiting example, the first pattern 14 comprises a first concentrated design element 44 and is elementally balanced. In yet another embodiment, the first concentrated design element 44 comprises brand information. In one nonlimiting example, the first concentrated design element 44 comprises a brand name. Exemplary brand names include but are not limited CHARMIN® bath tissue, BOUNTY® paper towels, ANGEL SOFT® bath tissue, BRAWNY® paper towels, SPARKLE® paper towels, and QUILTED NORTHERN® bath tissue, and the like. In another nonlimiting example, the first concentrated design element 44 can comprise brand information such as words that connote information about qualities or performance of a fibrous structure 11, including but not limited to “soft”, “strong” and/or “absorbent.” The first concentrated design element 44 may be partially disposed on the main centerline 24 such that a proximate end 44a of the first concentrated element 44 is disposed on the main centerline 24 and the distal end 44b is not disposed on the main centerline 24. For example, where the first concentrated design element 44 comprises a brand name, the beginning of the brand name can be disposed on the main centerline 24. In another nonlimiting example, the end of the brand name is disposed on the main centerline 24. Placing a brand name on the main centerline 24 allows the brand name to be a central focus of the end user.

Further to the above, the fibrous structure 11 may comprise a second concentrated design element 46. More specifically, the second pattern 16 may comprise the second concentrated design 46. The second concentrated design element 46 may be at least partially disposed in the central region 26. In one nonlimiting example, the second concentrated design element 46 is at least partially disposed on the main centerline 24. In a further nonlimiting example, a proximate end 46a of the second concentrated design element 46 is disposed on the main centerline 24 and a distal end 46b of the second concentrated design element 46 is not disposed on the main centerline 24. In another nonlimiting example, the second design element comprises brand information, including but not limited to a brand name. The beginning of the brand name may be disposed on the main centerline 24 and/or the end of the brand name may be disposed on the main centerline 24. In one embodiment, the second concentrated design element 46 may be a major design element having any of the characteristics of a major design element as described above. In a further embodiment, the second design 16 may comprise a second concentrated design element 46 and be elementally balanced.

In yet another embodiment, the fibrous structure 11 comprises both a first concentrated design element 44 and a second concentrated design element 46. In one nonlimiting example, the first concentrated design element 44 is disposed on a first side 24a of the main centerline 24, and the second concentrated design element 46 is disposed on a second side 24b of the main centerline 24, where the second side 24b is opposite the first side 24a. The disposition of the first concentrated design element 44 and the second concentrated design element 46 can attribute to elementally balancing an interlocking motif 18. In other words, the two concentrated design elements 44, 46 may be placed in relation to one another such that they counterbalance each other.

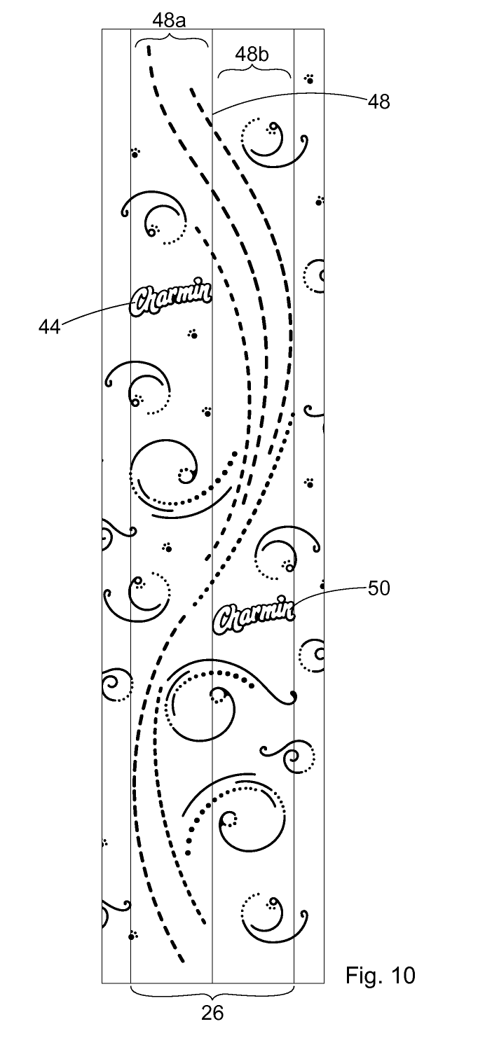

In a further embodiment shown in FIG. 10, the first pattern 14 comprises a first concentrated design element 44, a first pattern centerline 48 that extends longitudinally, and a third concentrated design element 50. In one nonlimiting example, the first concentrated design element 44 can be disposed on a first side 48a of the first pattern centerline 48, and the third concentrated design element 50 can be disposed on a second side 48b of the pattern centerline 48, where the second side 48b is opposite the first side 48a. The disposition of the first concentrated design element 44 and the third concentrated design element 50 can attribute to elementally balancing the first pattern 14. In other words, the two concentrated design elements 44, 50 may be placed in relation to one another such that the counterbalance each other within the pattern 14. The same principles can be applied to the second pattern (i.e., the second pattern 16 may comprise a second pattern centerline, and a fourth concentrated design element that is balanced with the second concentrated design element 46 (not shown)).

Likewise, the placement of the concentrated design elements 40 on opposite sides of a centerline 24 contributes to visual balance as a pattern 14, 16 or interlocking motif 18 appears more symmetrical and/or centered due to the alternating concentrated elements 40.

Concentrated design elements 40 may form a focal point for the end user due to their respective emboss and print areas compared to other elements 13 as well as their disposition on or near the centerline 24.

Balanced Non-Diagonal Patterns and/or Non-Diagonal Interlocking Motif

Using the principles discussed herein, a pattern 14, 16, 140 or interlocking motif 18 may be non-diagonal and still visually balanced and/or elementally balanced. In one embodiment, the interlocking motif 18 is non-diagonal. Repeating designs that are imparted on existing sanitary tissue products tend to be imparted at an angle. This is in part due to skewing of a design template on a manufacturer's emboss roll 300 (or similar apparatus) in order to prevent roll wear and/or vibration.

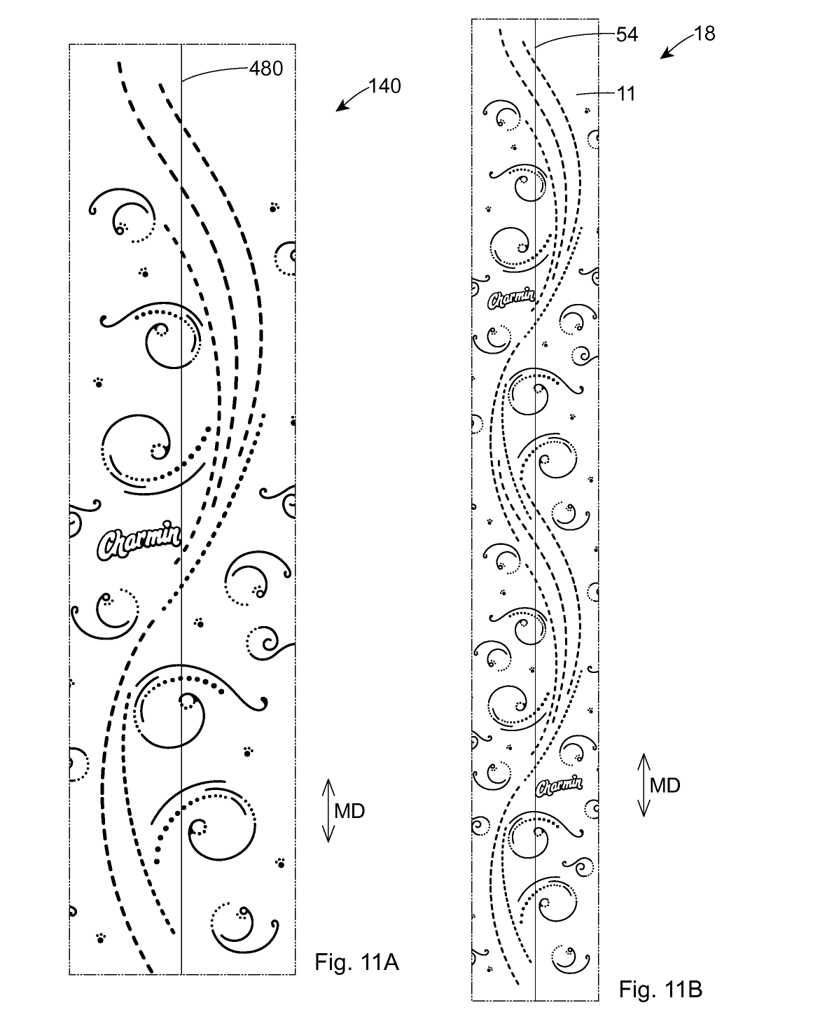

In the present invention, one or more of the patterns 14, 16, 140 and/or the interlocking motif 18 are non-diagonally oriented. In one nonlimiting example, an exemplary pattern 140 comprises a exemplary pattern centerline 480 (as shown in FIG. 11A). The exemplary pattern centerline 480 extends longitudinally throughout the fibrous structure 11 and can be substantially parallel to the MD. The exemplary pattern centerline 480 may be coincident with the main centerline 24 or may be a distance apart from the main centerline 24 and parallel to the main centerline. In another embodiment as shown in FIG. 11B, the interlocking motif 18 has an interlocking motif centerline 54 which extends longitudinally throughout the fibrous structure 11 and can be substantially parallel to the MD. The interlocking motif centerline 54 may be coincident with the main centerline 24 or may be a distance apart from the main centerline 24 and parallel to the main centerline 24.

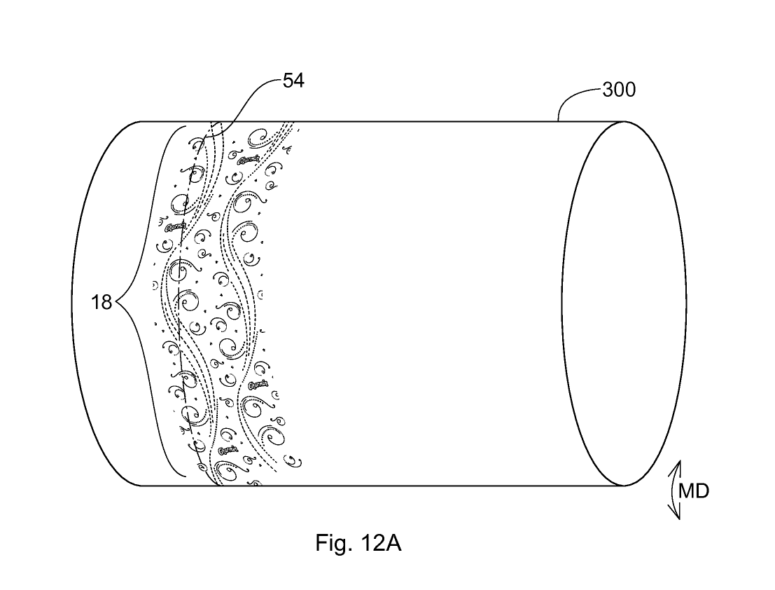

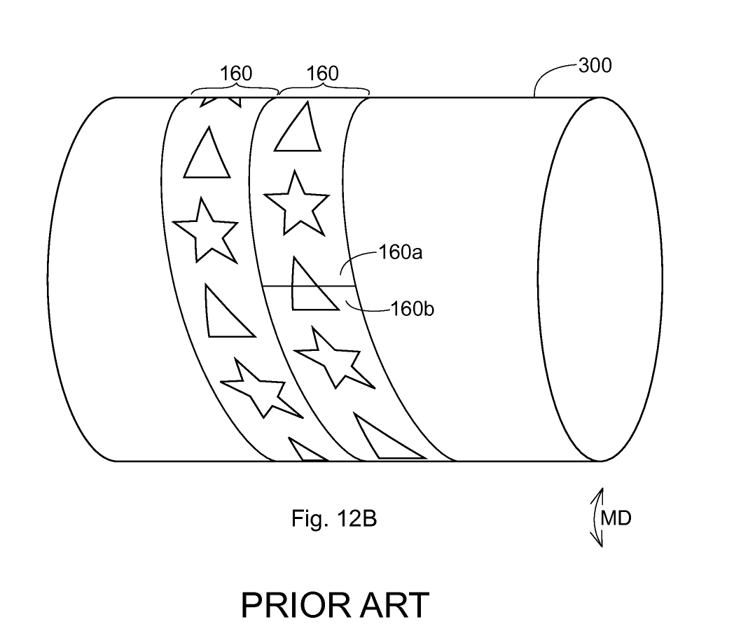

FIG. 12A depicts an interlocking motif 18 with an interlocking motif centerline 54 substantially parallel to the MD on an emboss roll 300. The interlocking motif 18 may be wrapped about the roll 300. In addition, the interlocking motif may repeat about the roll 300. In one nonlimiting example, the interlocking motif 18 may be repeated in a lock and step manner. FIG. 12B depicts a skewed pattern 160 as is known in the prior art. The skewed pattern 160 may be wrapped about the roll 300 and/or may repeat about the roll 300. In the case of embossing, because balance with the present invention is not accomplished by skewing, the interlocking motif 18 (and/or each pattern therein) may be made to fit different sized embossment rolls by altering the space between design elements 13, adding design elements 13 and/or subtracting design elements 13. One the other hand, to achieve balance in a skewed pattern 160 that wraps around the roll 300, the beginning 160a and end 160b of the pattern must align as shown in FIG. 12B. Thus, when translating a skewed pattern from a smaller roll to a larger roll, the entire pattern has to be enlarged or stretched, or the skew angle must be adjusted, to ensure the beginning 160a and end 160b of the pattern 160 align and thus accomplish elemental balance. Again, skewing precludes non-diagonal orientation (such as vertical alignment or horizontal alignment). The present inventors, however, have developed a means to align the design elements 13 in a non-diagonal manner and fit the patterns 14, 16 and/or interlocking motif 18 on different sized rolls without stretching. By avoiding stretching of the interlocking motif 18, patterns 14, 16 and/or design elements 13, the original design intent is better maintained. Indeed, changing the spacing between elements or adding or subtracting elements are less significant changes than elongating particular design elements 13. Moreover, the ability to fit patterns on different sized rolls without stretching reduces manufacturing costs and resources.

### Lock and Step Repeat

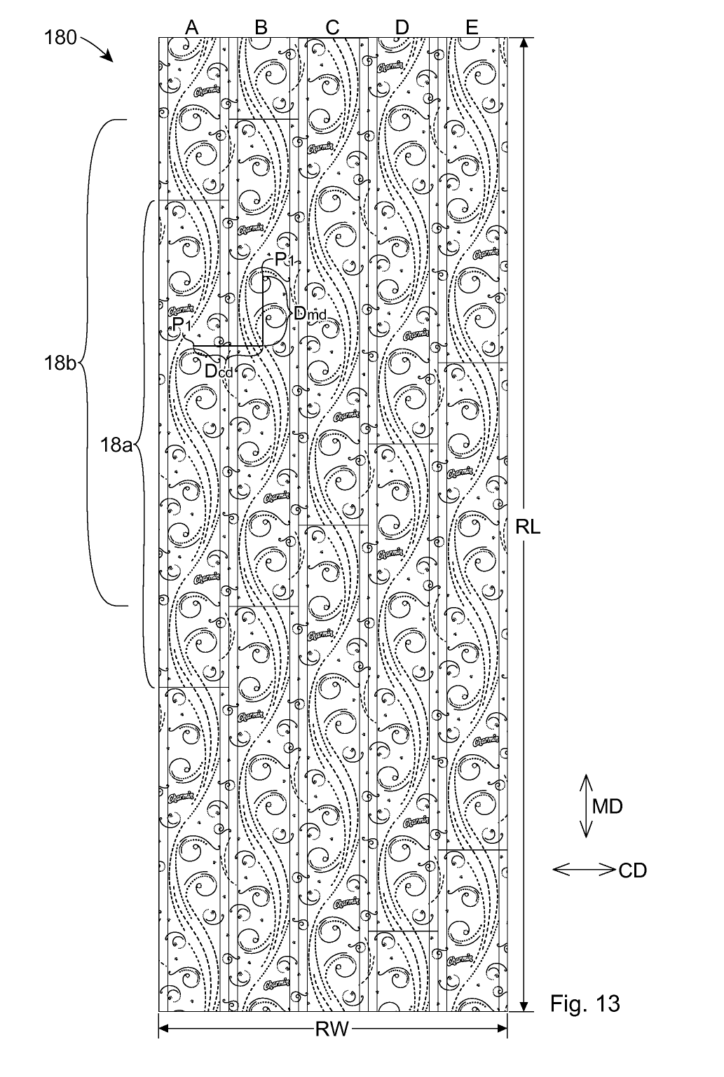

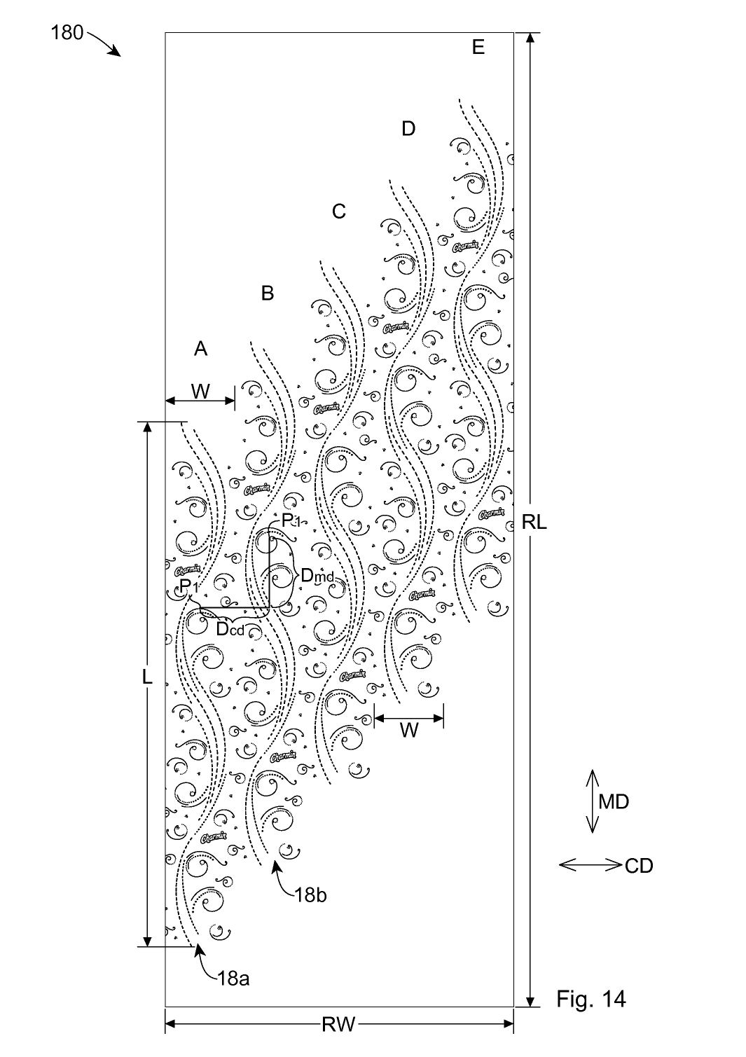

As shown in FIG. 13, a fibrous structure 11 of the present invention can comprise a repeating interlocking motif 180. The repeating motif 180 may have a repeat width, RW, in the cross-machine direction and/or a repeat length, RL, in the machine direction. The repeating interlocking motif 180 may comprise individual interlocking motifs 18 that repeat in a lock and step manner. In an embodiment depicted, for example, in FIG. 13, the interlocking motifs 18 repeat in both the MD and CD. The repeating motif 180 may repeat continuously throughout a fibrous structure 11 as shown in FIG. 13 or repeat throughout the fibrous structure 11 with areas of white space and/or other designs as shown in FIG. 14. Elements 13 within one interlocking motif 18a may overlap with elements 13 in an adjacent interlocking motif 18b.

In a further embodiment, as shown in FIG. 13, the repeating interlocking motif 180 forms columns of interlocking motifs 18 repeating in the MD. For illustration purposes, columns have been labeled A, B, C, D, and E in FIGS. 13 and 14. However, it should be recognized that any number of columns that is desirable may be utilized. The fibrous structure 11 may comprise a first column, A, and a second column, B, adjacent to the first column, A. Corresponding points, P₁, of adjacent interlocking motifs 18a, 18b in the first column, A, and second column, B, can be offset by a fixed distance, D_{md}, in the MD and a fixed distance, D_{cd}, in the CD. This offsetting can continue throughout the repeat width, RW. The offsetting can continue through the repeat length, RL, as well.

One of skill in the art will recognize that the repeating motif 180 could similarly form rows instead of columns of interlocking motifs 18 (not shown). Corresponding points, P₁, of interlocking motifs 18 in adjacent rows could be offset a fixed D_{cd}, in the CD and a fixed distance, D_{md}, in the MD as well. This offsetting could continue throughout the repeat width, RW. The offsetting could continue through the repeat length, RL, as well.

Further to the above, each interlocking motif 18 may comprise one or more patterns 14, 16 that interlock, such as by overlapping. The patterns 14, 16 may interlock in any of the manners described above or in any way known in the art. In addition, each interlocking motif 18 can be non-diagonal. Further, each interlocking motif 18 may comprise a width, W, in the cross machine direction and a length, L, in the machine direction. In one nonlimiting example, the width, W, of the interlocking motif 18 is substantially equal to the strip width, SW.

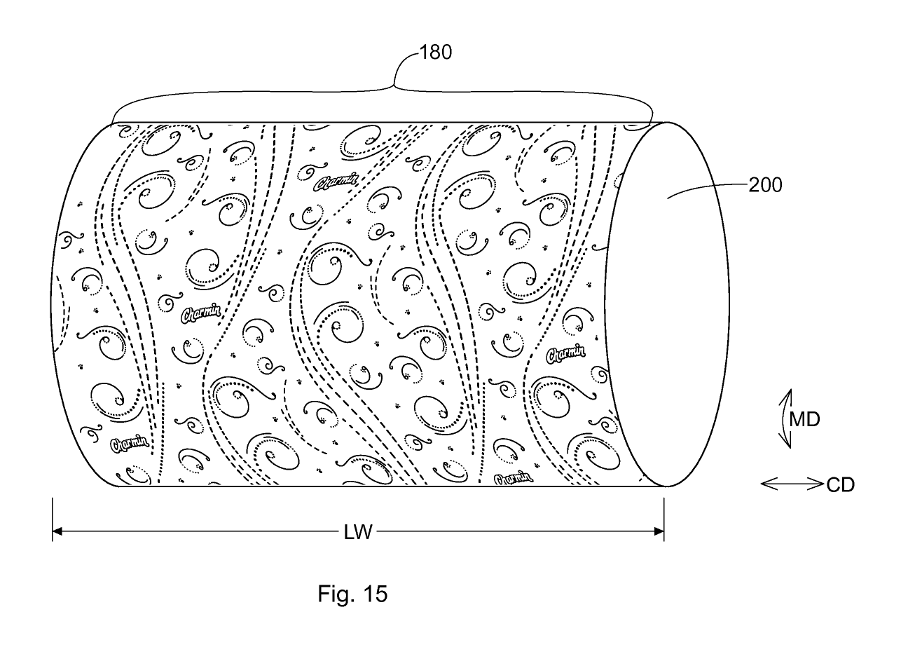

In an embodiment, the fibrous structure 11 can be convolutely wound into a log 200, such as a log 200 used in the manufacturing of sanitary tissue products 12. The repeating interlocking motif 180 may be helixed about the log 200 as shown in FIG. 15. The helixed repeating interlocking motif 180 may be non-diagonal. This helixing without imposing a diagonal orientation is possible through the lock and step repeat of the repeating interlocking motif 180. Helixing or spiraling also occurs when skewing a pattern. However, skewing precludes vertical and/or horizontal alignment of a pattern. In other words, the patterns or motif are always at an angle (i.e., diagonal) when skewing is used. The log 200 may have a log width, LW, in the CD of about 80 inches to about 120 inches, or about 98 inches to about 102 inches, or up to about 150 inches. In one nonlimiting example, the repeat width, RW, is substantially equivalent to the log length, LW.

The repeating motif 180 may be elementally balanced and/or visually balanced. This may be achieved through the use of individual items that are balanced such as balanced patterns 14, 16 and/or balanced interlocking motifs 18. Further, the repetition of balanced interlocking motifs 18 ensures substantial balance throughout the repeat length, RL, and repeat width, RW. Likewise, repeating in a lock and step manner permits the arrangement of design elements 13 such that balance is further ensured without having to skew or manually place elements 13.

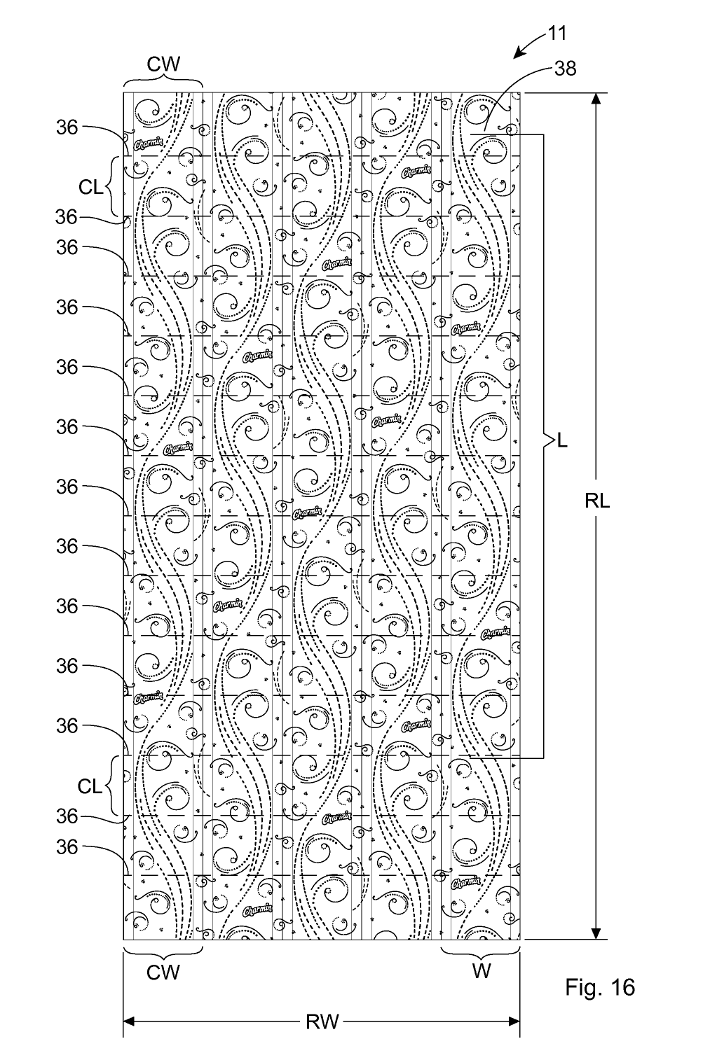

Turning to FIG. 16, the fibrous structure may comprise a consumer-sized length, CL. In one nonlimiting example, the consumer-sized length, CL is less than the length, L, of the interlocking motif 18. In this way, as discussed above, the end user may perceive a complex design, as the design on adjacent consumer-sized sheets 38 may differ. In other words, the consumer is less likely to perceive the repetition of the interlocking motifs 18. In one nonlimiting example, the consumer-sized length, CL, is about 3 inches to about 15 inches, including all 0.1 increments therebetween. In such example, the consumer-sized length, CL, can be substantially equivalent to the length of a sheet 38 defined by a line of weakness 36. In one nonlimiting example, the interlocking motif length, L, is greater than one times the consumer-length, CL, or about three times greater, or about four times greater, or about three to about eight times greater, or about seven times greater than the consumer-sized length, CL. The consumer-sized length, CL, may be defined by a line of weakness 36.

In yet another embodiment, the fibrous structure 11 comprises a consumer-sized width, CW. The consumer-sized width, CW, may be about 3 to about 15 inches, including all 0.1 increments therebetween. In one nonlimiting example, the consumer-sized width, CW, is substantially equivalent to the strip width, SW. In another nonlimiting example, the consumer-sized width, CW, is less than or equal to the width, W, of the interlocking motif 18. In this way, as discussed above, the end user may perceive a complex design, as the design on adjacent consumer-sized sheets 38 may differ. In another nonlimiting example, the consumer-sized width, CW, is less than the repeat width, RW. In this way, the consumer is less likely to perceive the repetition of the interlocking motifs 18, and thereby the design on the consumer product may appear more complex than the underlying template. By way of example, the repeat width, RW, may be greater than one times the consumer-sized width, or about three to about eight times, or about seven times greater than the consumer-sized width, CW. In one embodiment, the sheet 38 has the dimensions of a consumer-sized width, CW, and a consumer-sized length, CL.

### Continuing Design

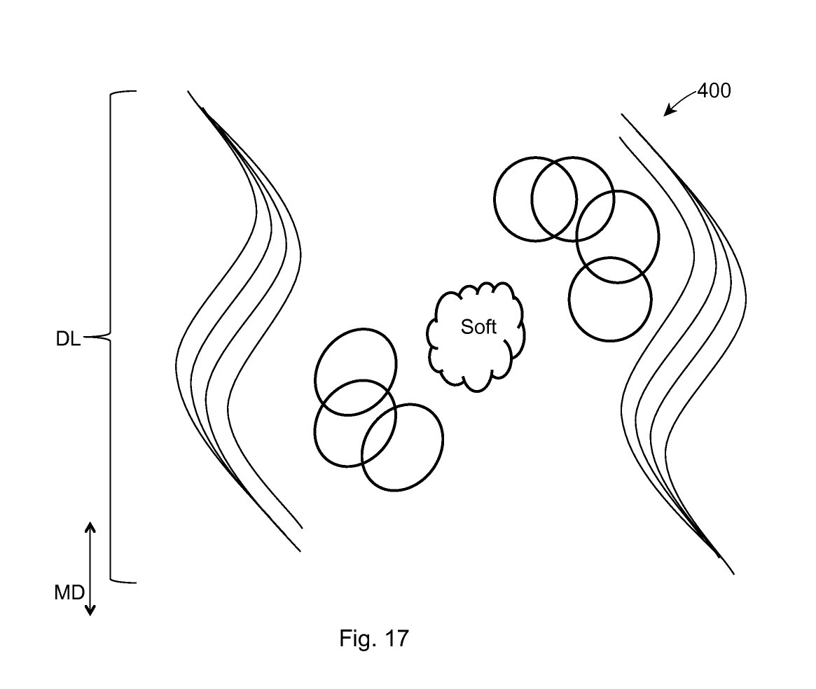

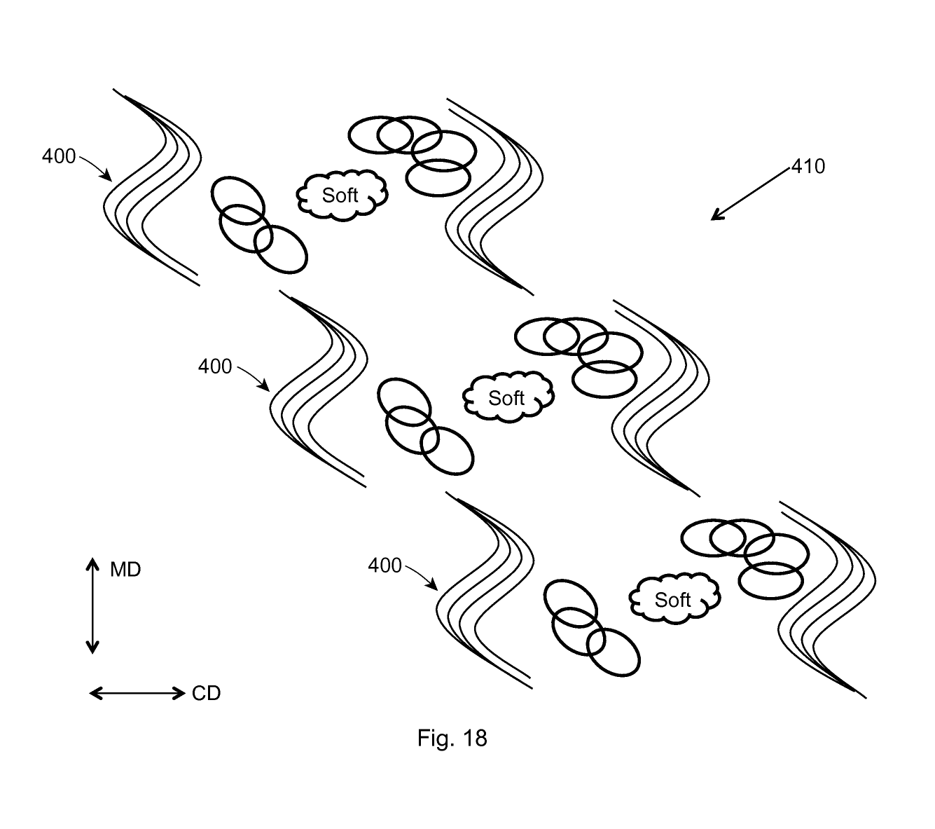

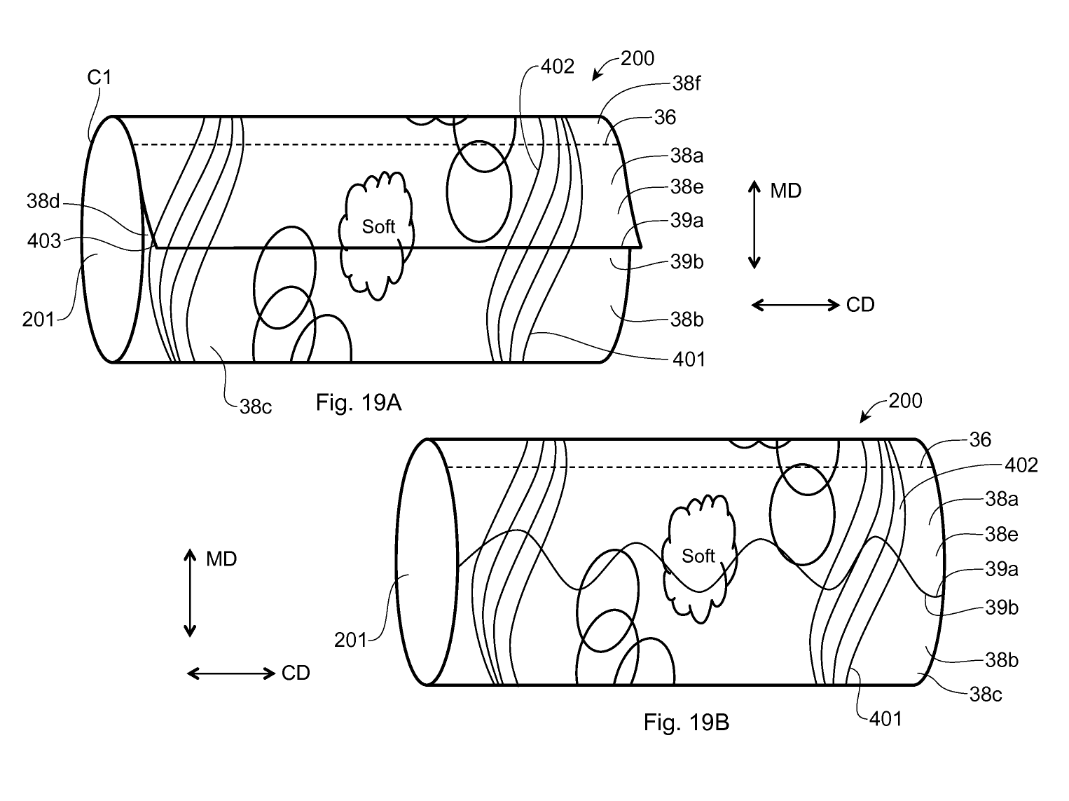

In a further embodiment, the fibrous structure 11 comprises a continuing design 400. The continuing design 400 may comprise one or more patterns 14, 16, 140 and/or an interlocking motif 18. The continuing design 400 can have a continuing design length, DL, in the machine direction as shown in FIG. 17. Further, as shown in FIG. 18, the continuing design 400 may be disposed on the fibrous structure 11 in a repetitive manner to create a repeating continuing design 410. The continuing design 400 may be repeated in the machine direction, cross machine direction or combinations thereof. In one nonlimiting example, the continuing design 400 is repeated in a lock and step manner as shown in FIG. 18 and described above. Turning to FIGS. 19A and 19B, the fibrous structure 11 may be convolutely wound into a log 200 having a circumference, C₁. In one embodiment, the circumference, C₁, may be determined by measuring the diameter of the log 200 on the side 201 of the log 200, to the nearest 0.01 inch and multiplying the diameter by π. Where the log 200 has a varying diameter, the largest diameter may be used for the calculation of the circumference. In another embodiment, the circumference, C₁, may be determined by measuring the Original Roll Diameter in accordance with the Percent Compressibility Test Method herein, and multiplying the Original Roll Diameter by π. In an embodiment, the circumference, C₁, may be from about 8 inches to about 25 inches, or from about 11 inches to about 18 inches, or from about 12 to about 14 inches, or from about 13 inches to about 21 inches, or from about 15 inches to about 17 inches, reciting, for each of the disclosed ranges, all 1 inch increments therebetween.

The log 200 will further comprise a terminal sheet 38a, which is the last sheet 38 (i.e., the outermost sheet 38) on the log 200 and an underlying sheet 38b, which comprises the next outmost layer of the log 200. The terminal sheet 38a comprises a terminal end 39a, which lands on the underlying sheet 38b at a landing position 39b on the underlying sheet 38b. When the log is completely wound, a covered portion 38d of the underlying sheet 38b will be disposed underneath the terminal sheet 38a and another portion 38c of the underlying sheet 38b, the visible portion 38c, will be adjacent to the terminal end 39a of the terminal sheet 38a. As shown in FIGS. 19A and 19B, the terminal end 39a may be substantially straight or curvilinear and may generally extend in the cross machine direction. In an embodiment, the circumference, C₁, is substantially equivalent to the length of the continuing design, DL (i.e., C₁=DL). In such embodiment, the continuing design 400 will visually continue from the terminal end 39a of the terminal sheet 38a to the visible portion 38c on the underlying sheet 38b.

In other words, a first segment 401 of the continuing design 400 that is disposed on the visible portion 38c of the underlying sheet 38b will be visually uninterrupted with a second segment 402 of the continuing design 400 that is disposed on the terminal sheet 38a, such that the two segments 401, 402 will appear as a whole design 400 even though those particular segments 401, 402 were not initially printed and/or embossed together to form the whole 400. Rather, the first segment 401 was initially printed and/or embossed together with a third segment 403 to form the whole design 400, the third segment 403 being disposed on the covered portion 38d of the underlying sheet 38b once the fibrous structure 11 is wound.

In contrast to a visually continuous design, segments of an interrupted design would appear offset, misaligned, discontinuous or otherwise noticeably different from the original design.

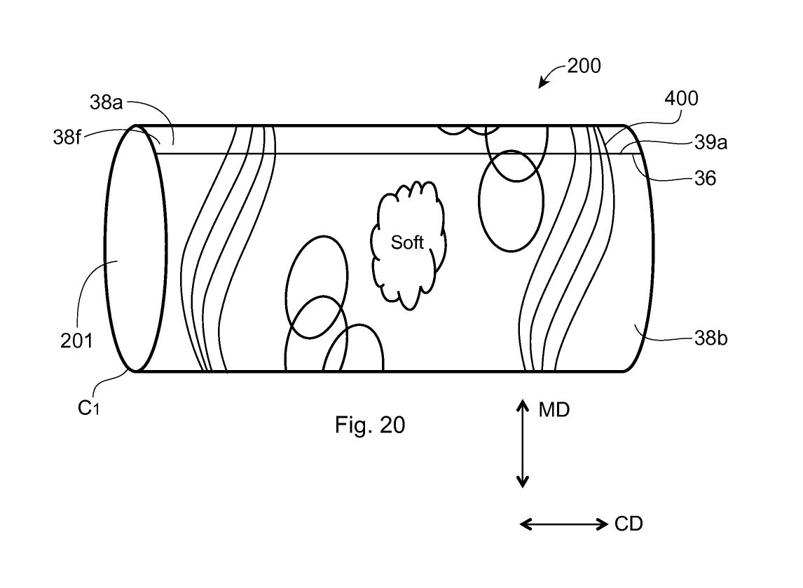

In a further embodiment, a portion 38e of the terminal sheet 38a may be removed, defining a new terminal end 39a (see FIGS. 19A and 20). For as long as the circumference, C₁, remains substantially equivalent to the design length, DL, the continuing design 400 may visually continue between the remaining portion 38f of the terminal sheet 38a and the adjacent, visible portion of underlying sheet 38c, regardless of the dimensions of the removed portion 38e. In one nonlimiting example, the fibrous structure comprises one or more lines of weakness 36, such as a perforation, as depicted in FIGS. 19A, 19B and 20. As illustrated in FIG. 20, the line of weakness 36 may be coincident with the terminal end 39a and the continuing design 400 may continue between the terminal sheet 38a and the underlying sheet 38b such that the continuing design 400 is visually uninterrupted over the line of weakness 36. For the purposes of this disclosure, lines of weakness 36 and terminal ends 39a themselves do not constitute visual interruptions of the continuing design 400.

### Method

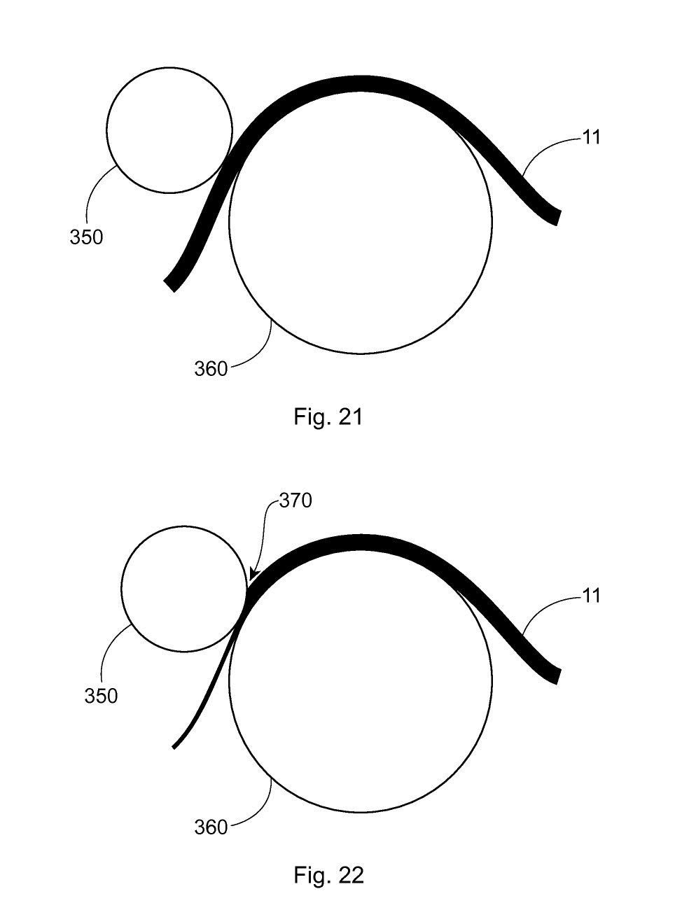

The interlocking motif 18, the repeating interlocking motif 180, continuing design 400 and/or repeating continuing design 410 of the present invention may be imparted onto the fibrous structure 11 by any suitable means including printing and/or embossing. In one embodiment, the interlocking motif 18 or continuing design 400 is imparted by an imparting apparatus 350. The imparting apparatus 350 may comprise an apparatus suitable for embossing. For example, the interlocking motif 18 or continuing design 400 can be disposed on an embossment roll 300 as shown in FIG. 12A. In another embodiment, the imparting apparatus 350 may comprise an apparatus suitable for printing. For example, the interlocking motif 18 or continuing design 400 can be disposed on a printing apparatus such as a gravure roll or otherwise programmed into a printer. In either case (embossing or printing), the imparting apparatus 350 may be used in conjunction with a backing surface 360, such as a backing roll as shown in FIGS. 21 and 22. The fibrous structure 11 may be driven over the backing surface 360. In one nonlimiting example shown in FIG. 21, the backing surface 360 and imparting apparatus 350 may be positioned at a distance away from each other. In such case, the distance between the backing surface 360 and imparting apparatus 350 may be substantially equal to or smaller than the caliper of the fibrous structure 11. Alternatively, as depicted in FIG. 22, the imparting apparatus 350 may form a nip 370 with the backing surface 360. The fibrous structure 11 may contact the imparting apparatus 350 at the nip 370. The backing surface 360 may be made of any material suitable for providing a surface for the fibrous structure 11 and/or providing pressure to facilitate embossing or printing, such as providing compression and/or pressure at the nip 370. In another nonlimiting example, the imparting apparatus 350 may be suitable for both printing and embossing—such as a system comprising a printer and an emboss roll 300. The interlocking motif 18 or continuing design 400 imparted to the fibrous structure substantially mirrors the interlocking motif structure or continuing design structure disposed on the imparting apparatus, such that the visual appearance of the design imparted to the fibrous structure is effectively a one-to-one replication, of the design of the imparting structure.

In a further embodiment, the interlocking motif 18 and/or patterns 14, 16, 140 comprising the interlocking motif 18 are visually balanced and/or elementally balanced in accordance with the teachings herein. Further in one embodiment, interlocking motif 18 is elementally balanced before imparting the interlocking motif 18 onto the fibrous structure 11. In one nonlimiting example, the interlocking motif 18 may be elementally balanced and/or visually balanced as it is being imparted onto the imparting apparatus 350.

In addition, the interlocking motif 18 may be imparted on the fibrous structure 11 such that the interlocking motif centerline 54 is substantially parallel to the machine direction. Likewise, a pattern 140 forming a part of the interlocking motif 18 may be imparted to the fibrous structure 11 such that the pattern centerline 480 is substantially parallel to the machine direction.

The interlocking motif 18 may include any of the features described above, including but not limited to any of types of design elements 13 and/or patterns 14, 16, 140 described herein. Further, the interlocking motif 18 (and/or patterns 14, 16 comprising the interlocking motif 18) may be non-diagonal. Likewise, the continuing design 400 may include any of the features described above, including but not limited to the design length, DL. The continuing design may comprise an interlocking motif 18 or a pattern 14, 16, 140.

In addition, the interlocking motif 18 or continuing design 400 may be imparted onto the fibrous structure 11 repeatedly to form a repeating interlocking motif 180 or repeating continuing design 410 respectively; the interlocking motif 18 or continuing design 400 may be repeated in the CD and/or in the MD. In one embodiment, the interlocking motif 18 or continuing design 400 is imparted onto the fibrous structure 11 in a lock and step repeating manner as discussed above. In one nonlimiting example, the interlocking motif 18 or continuing design 400 is helixed about the imparting apparatus 350.

After imparting the interlocking motif 18 or repeating continuing design 410 onto the fibrous structure 11, the method can further include winding the fibrous structure into a convolutely wound log 200. In another embodiment, the method may include dividing the fibrous structure into a consumer-sized length, CL, and/or a consumer-sized width, CW, in accordance with the description above related to said dimensions. The method can further include winding the fibrous structure 11 into a log 200 having a circumference, C₁, wherein the circumference, C₁, is substantially equivalent to the length of the continuing design, DL, as described above.

### Percent Compressibility Test Method

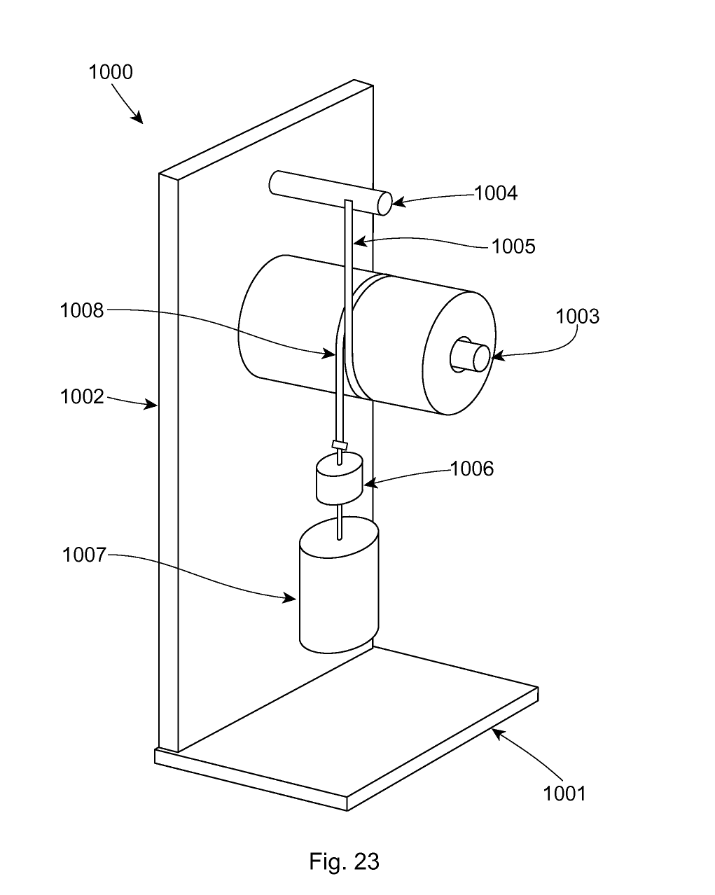

Percent Roll Compressibility (Percent Compressibility) is determined using the Roll Diameter Tester 1000 as shown in FIG. 23. It is comprised of a support stand made of two aluminum plates, a base plate 1001 and a vertical plate 1002 mounted perpendicular to the base, a sample shaft 1003 to mount the test roll, and a bar 1004 used to suspend a precision diameter tape 1005 that wraps around the circumference of the test roll. Two different weights 1006 and 1007 are suspended from the diameter tape to apply a confining force during the uncompressed and compressed measurement. All testing is performed in a conditioned room maintained at about 23° C.±2 C.° and about 50%±2% relative humidity.

The diameter of the test roll is measured directly using a Pi® tape or equivalent precision diameter tape (e.g. an Executive Diameter tape available from Apex Tool Group, LLC, Apex, N.C., Model No. W606PD) which converts the circumferential distance into a diameter measurement so the roll diameter is directly read from the scale. The diameter tape is graduated to 0.01 inch increments with accuracy certified to 0.001 inch and traceable to NIST. The tape is 0.25 in wide and is made of flexible metal that conforms to the curvature of the test roll but is not elongated under the 1100 g loading used for this test. If necessary the diameter tape is shortened from its original length to a length that allows both of the attached weights to hang freely during the test, yet is still long enough to wrap completely around the test roll being measured. The cut end of the tape is modified to allow for hanging of a weight (e.g. a loop). All weights used are calibrated, Class F hooked weights, traceable to NIST.

The aluminum support stand is approximately 600 mm tall and stable enough to support the test roll horizontally throughout the test. The sample shaft 1003 is a smooth aluminum cylinder that is mounted perpendicularly to the vertical plate 1002 approximately 485 mm from the base. The shaft has a diameter that is at least 90% of the inner diameter of the roll and longer than the width of the roll. A small steal bar 1004 approximately 6.3 mm diameter is mounted perpendicular to the vertical plate 1002 approximately 570 mm from the base and vertically aligned with the sample shaft. The diameter tape is suspended from a point along the length of the bar corresponding to the midpoint of a mounted test roll. The height of the tape is adjusted such that the zero mark is vertically aligned with the horizontal midline of the sample shaft when a test roll is not present.

Condition the samples at about 23° C.±2 C.° and about 50%±2% relative humidity for 2 hours prior to testing. Rolls with cores that are crushed, bent or damaged should not be tested. Place the test roll on the sample shaft 1003 such that the direction the paper was rolled onto its core is the same direction the diameter tape will be wrapped around the test roll. Align the midpoint of the roll's width with the suspended diameter tape. Loosely loop the diameter tape 1004 around the circumference of the roll, placing the tape edges directly adjacent to each other with the surface of the tape lying flat against the test sample. Carefully, without applying any additional force, hang the 100 g weight 1006 from the free end of the tape, letting the weighted end hang freely without swinging. Wait 3 seconds. At the intersection of the diameter tape 1008, read the diameter aligned with the zero mark of the diameter tape and record as the Original Roll Diameter to the nearest 0.01 inches. With the diameter tape still in place, and without any undue delay, carefully hang the 1000 g weight 1007 from the bottom of the 100 g weight, for a total weight of 1100 g. Wait 3 seconds. Again read the roll diameter from the tape and record as the Compressed Roll Diameter to the nearest 0.01 inch. Calculate percent compressibility to the according to the following equation and record to the nearest 0.1%:

$$\% Compressibility = \frac{( Original Roll Diameter ) - ( Compressed Roll Diameter )}{Original Roll Diameter} \times 100$$

Repeat the testing on 10 replicate rolls and record the separate results to the nearest 0.1%. Average the 10 results and report as the Percent Compressibility to the nearest 0.1%.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manufacturing a strip of a fibrous structure, the method comprising the steps of:
providing a strip, the strip having:
a strip width disposed between a first edge and a second edge opposite the first edge,
a main centerline extending in a longitudinal direction and being substantially equidistant between the first edge and the second edge,
a central region extending in a longitudinal direction and having a central width, wherein the central width is less than the strip width and the central region extends laterally outwardly on each side of the main centerline, and
a first edge region and a second edge region, wherein the first edge region and the second edge region each extend outward from the central region toward at least one of the first edge and the second edge; and
imparting an interlocking motif onto the strip, the interlocking motif comprising a first pattern and a second pattern interlocked with the first pattern, wherein:
the first pattern comprises a first major design element and a first minor design element and the first major design element is at least partially imparted in the central region and the first minor design element is at least partially imparted in one of the group consisting of the first edge region and the second edge region; and
the second pattern comprises a second major design element and a second minor design element and the second major design element is at least partially imparted in the central region and the second minor design element is at least partially imparted in one of the group consisting of the first edge region and the second edge region.

2. The method of claim 1 further comprising the step of repeating the interlocking motif on the strip in a lock and step manner.

3. The method of claim 1 further comprising the step of perforating the strip to impart a line of weakness and define a plurality of sheets wherein the interlocking motif extends greater than one sheet.

4. The method of claim 1 wherein imparting the interlocking motif is done by one of the group consisting of embossing, printing and combinations thereof.

5. The method of claim 1 further comprising the step of elementally balancing the interlocking motif.

6. The method of claim 1 wherein the first pattern and second pattern interlock in the machine direction.

7. The method of claim 1 wherein the first pattern and the second pattern interlock in the cross machine direction.

8. The method of claim 1 wherein the first pattern and the second pattern are different.

9. The method of claim 1 further comprising the step of imparting the interlocking motif such that the interlocking motif centerline is substantially parallel to the machine direction.

10. The method of claim 1 further comprising the step of imparting one or more concentrated design elements, wherein at least one of the one or more concentrated design elements are partially disposed on the main centerline.

11. The method of claim 10 wherein the at least one of the one or more concentrated design elements comprises brand information.

12. The method of claim 1 further comprising the step of imparting a third design element wherein the design element is in the shape of a brand insignia.

13. The method of claim 12 further comprising the step of at least partially disposing the third design element over an adhesive site.

14. The method of claim 10 further comprising the step of balancing the at least one of the one or more concentrated design elements with a one or more non-concentrated design elements.

15. The method of making a fibrous structure having an interlocking motif, the method comprising the steps of:
providing a fibrous structure having a machine direction and a cross machine direction;
imparting an interlocking motif on the fibrous structure, the interlocking motif having:
a width, W, in the cross machine direction and a length, L, in the machine direction;
an interlocking motif centerline extending longitudinally, wherein the interlocking motif centerline is substantially parallel to the machine direction; and
a first pattern and a second pattern partially overlapping the first pattern; and
repeating the interlocking motif in a lock and step manner to form a repeating interlocking motif on the fibrous structure, the repeating interlocking motif having a repeat width, RW, in the cross machine direction.

16. The method of claim 15 further comprising the step of winding the fibrous structure into a convolutely wound log such that the repeating interlocking motif is helixed about the convolutely wound log.

17. The method of claim 16 wherein the convolutely wound log comprises a circumference, C₁, wherein the circumference, C₁, is substantially equivalent to the length, L, of the interlocking motif.

18. The method of claim 15 further comprising the step of dividing the fibrous structure into a consumer-sized length, CL, wherein the consumer-sized length, CL, is less than the length, L, of the interlocking motif.

19. The method of claim 15 further comprising the step of dividing the fibrous structure into a consumer-sized width, CW, wherein the consumer-sized width, CW, is less than the repeat width, RW, of the repeating interlocking motif.

20. A method of creating a continuing design, the method comprising the steps of:
providing a fibrous structure having a machine direction and a cross machine direction;
imparting a repeating design on the fibrous structure, wherein the repeating design comprises a design having a design length, DL, in the machine direction and said design is repeated in the machine direction throughout the repeating design; and
winding the fibrous structure into a convolutely wound log having a circumference, C₁, wherein the circumference, C₁, is substantially equivalent to the design length, DL.
